(19) United States
(12) Patent Application Publication
(10) Pub. No.: US 2025/0291576 A1
(43) Pub. Date: Sep. 18, 2025

(54) PROGRAM UPDATE METHOD AND INFORMATION PROCESSING SYSTEM

(71) Applicant: SEIKO EPSON CORPORATION, Tokyo (JP)

(72) Inventors: Akihiro TAMURA, SAPPORO-SHI (JP); Jinchen LIU, BEIJING (CN)

(21) Appl. No.: 19/077,130

(22) Filed: Mar. 12, 2025

(30) Foreign Application Priority Data
Mar. 13, 2024 (CN) 202410285317.8

(51) Int. Cl. G06F 8/65; H04L 67/00

(52) U.S. Cl. CPC G06F 8/65; H04L 67/34

(57) ABSTRACT

A second server 200 capable of communicating with a first server 100 and a terminal device 300 stores a first program PG1 as a web application executed in response to a request from the terminal device 300, the second server 200 determines whether to update the first program PG1 to a second program PG2 in which a part of functions of the first program PG1 is restricted, when it is determined to update the first program PG1 to the second program PG2, the second server 200 transmits update request information REQu for requesting to update the first program PG1 to the second program PG2 to the first server 100, the first server 100 transmits the second program PG2 to the second server 200 based on the update request information REQu, and the second server 200 updates the first program PG1 to the second program PG2.

The present application is based on, and claims priority from CN Application Serial Number 202410285317.8, filed Mar. 13, 2024, the disclosure of which is hereby incorporated by reference herein in its entirety.

### BACKGROUND

### 1. Technical Field

The present disclosure relates to a program update method and an information processing system.

### 2. Related Art

In the related art, an application program used by a user is updated. JP-A-2020-170230 discloses that an update notification is displayed on a display unit of a mobile terminal device of a user when an importance level of update for a program is high. For example, when an update notification is displayed on the display unit of the mobile terminal device, the user performs an operation for updating a program stored in the mobile terminal device.

In some cases, it is desirable for an application program to restrict a specific function in a period in which a specific event such as an emergency occurs. For example, it is conceivable to update a program to a program in which a specific function is restricted during a period in which a specific event occurs. However, in the method disclosed in JP-A-2020-170230 in which a user who confirmed the update notification performs an operation for updating the program, when the user does not permit the update of the program, the specific function to be restricted is not restricted. Therefore, it is desired to quickly restrict the specific function of the program when a specific event occurs.

### SUMMARY

A program update method according to the present disclosure including: storing, by a second server device configured to communicate with a first server device and a terminal device, a first program as a program to be executed in response to a request from the terminal device; determining, by the second server device, whether to update the first program to a second program in which a part of functions of the first program is restricted; transmitting, by the second server device, update request information for requesting to update the first program to the second program to the first server device when it is determined to update the first program to the second program; transmitting, by the first server device, the second program to the second server device based on the update request information; and updating, by the second server device, the first program to the second program.

A program update method according to the present disclosure including: storing, by a server device configured to communicate with a terminal device, a first program executed in response to a request from the terminal device and restriction information indicating a function to be restricted among functions of the first program; and restricting, by the server device, the function of the first program based on the restriction information when it is determined to restrict a part of functions of the first program.

An information processing system according to the present disclosure including: a first server device including a first communication device, a first storage device configured to store a first program and a second program in which a part of functions of the first program is restricted, and a first control device configured to transmit the first program and the second program via the first communication device; a second server device including a second communication device, a second storage device configured to store the first program and the second program as a program executed in response to a request from a terminal device, and a second control device configured to determine which of the first program and the second program is to be executed as the program when the second communication device receives execution request information for requesting execution of the program, configured to execute the second program when it is determined to execute the second program, and configured to transmit result information indicating an execution result of the program via the second communication device, when it is determined to update the first program to the second program, the second control device being configured to transmit, to the first server device via the second communication device, update request information for requesting to update the first program to the second program; and the terminal device including a third communication device, a display device, and a third control device configured to transmit the execution request information to the second server device via the third communication device, and configured to cause the display device to display an execution result of the program based on the result information when the third communication device receives the result information from the second server device.

### BRIEF DESCRIPTION OF THE DRAWINGS

FIG. 1 is a diagram showing an example of an information processing system according to a first embodiment.

FIG. 2 is a diagram showing an example of an operation of the information processing system according to the first embodiment.

FIG. 3 is a flowchart showing an example of an operation of a first server according to the first embodiment.

FIG. 4 is a flowchart showing an example of an operation of a second server according to the first embodiment.

FIG. 5 is a diagram showing an example of an information processing system according to a second embodiment.

FIG. 6 is a diagram showing an example of an operation of the information processing system according to the second embodiment.

FIG. 7 is a flowchart showing an example of an operation of a terminal device according to the second embodiment.

FIG. 8 is a diagram showing an example of a screen displayed on the terminal device as an execution result of a web application.

FIG. 9 is a diagram showing an example of an information processing system according to a third embodiment.

FIG. 10 is a diagram showing an example of an operation of the information processing system according to the third embodiment.

FIG. 11 is a flowchart showing an example of an operation of a second server according to the third embodiment.

FIG. 12 is a diagram showing an example of an information processing system according to a fourth embodiment.

FIG. 13 is a diagram showing an example of an operation of the information processing system according to the fourth embodiment.

FIG. 14 is a flowchart showing an example of an operation of a second server according to the fourth embodiment.

FIG. 15 is a diagram showing an example of an information processing system according to a fifth embodiment.

FIG. 16 is a diagram showing an example of an operation of the information processing system according to the fifth embodiment.

### DESCRIPTION OF EMBODIMENTS

An aspect for implementing the present disclosure will hereinafter be described with reference to the drawings. However, in the drawings, dimensions and scales of elements are made different from actual ones as appropriate. The following embodiments are preferred specific examples of the present disclosure and therefore various technically preferable limitations are imposed thereon, however, the scope of the present disclosure is not limited to the embodiments unless there is description that the present disclosure is limited thereto in particular in the following description.

### 1. First Embodiment

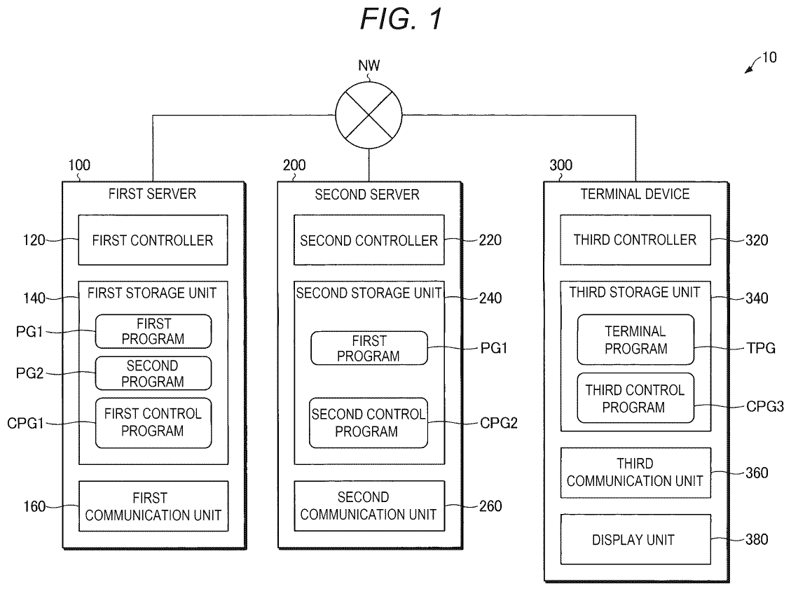

First, an overview of an information processing system 10 according to a first embodiment will be described with reference to FIG. 1.

FIG. 1 is a diagram showing an example of the information processing system 10 according to a first embodiment. In the embodiment, it is assumed that the information processing system 10 is used for execution of a web application or the like. The web application is an application program used on a website via a network NW such as the Internet. The web application is an example of a “program”.

The information processing system 10 includes a first server 100, a second server 200, and a terminal device 300. The first server 100, the second server 200, and the terminal device 300 are connected to, for example, a network NW. The first server 100 is an example of a “first server device”, and the second server 200 is an example of a “second server device”. Each of the first server 100, the second server 200, and the terminal device 300 is implemented as a single device or a plurality of devices implemented separately from one another.

For example, any information processing device can be adopted as the first server 100. For example, the first server 100 is an information processing device that provides the second server 200 with at least one of a first program PG1 and a second program PG2 that are stored in a first storage unit 140 to be described later as a web application. In the embodiment, it is assumed that the first server 100 provides one of the first program PG1 and the second program PG2 to the second server 200. The second program PG2 is a program in which a part of functions of the first program PG1 is restricted. For example, the second program PG2 is executed instead of the first program PG1 in a specific period in which a specific event such as an emergency occurs. Hereinafter, a period other than the specific period may be referred to as a normal period. Hereinafter, among the functions of the first program PG1, a function restricted in the specific period is also referred to as a specific function. The specific functions may be one or more.

The first server 100 includes, for example, a first controller 120, the first storage unit 140, and a first communication unit 160 that is hardware for communicating with other devices such as the second server 200. The first communication unit 160 performs communication by a wired method or a wireless method. The first communication unit 160 includes, for example, a communication terminal or antenna, and a communication circuit. The first communication unit 160 is an example of a first communication device.

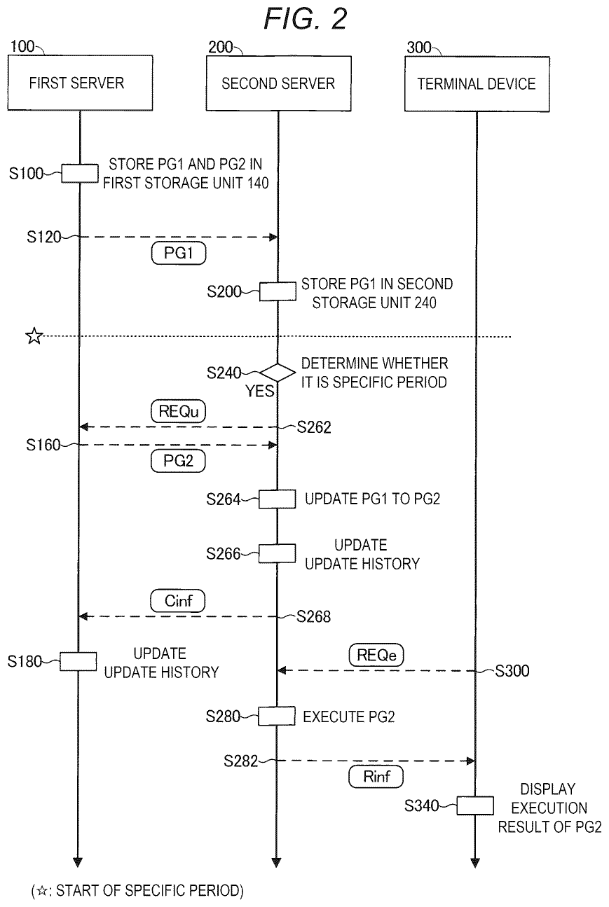

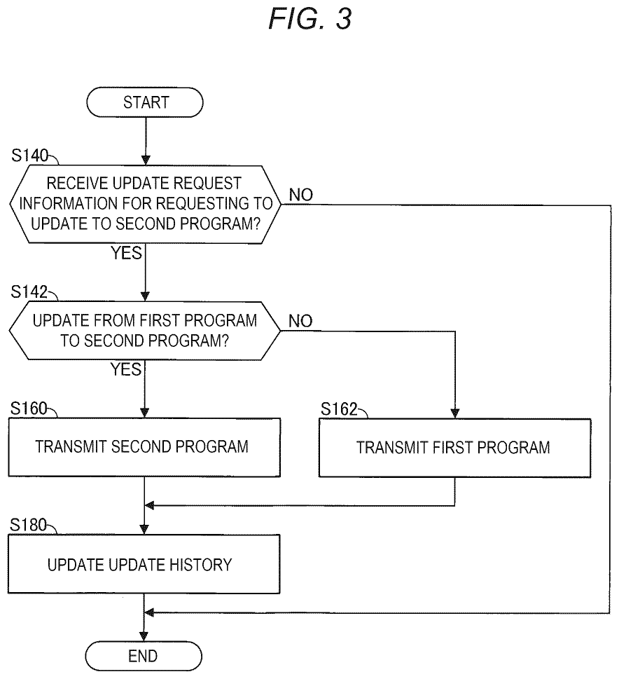

The first controller 120 includes one or more processors such as a central processing unit (CPU). The first controller 120 is an example of a first control device. Instead of or in addition to the CPU, the first controller 120 may include a programmable logic device such as a field-programmable gate array (FPGA). For example, the first controller 120 executes a first control program CPG1 stored in the first storage unit 140 and operates according to the first control program CPG1 to control the entire first server 100. The first controller 120 has a function of transmitting one of the first program PG1 and the second program PG2 to the second server 200 via the first communication unit 160 by executing the first control program CPG1. An operation of the first controller 120 and the like when the first controller 120 executes the first control program CPG1 will be described with reference to FIGS. 2 and 3. The first control program CPG1 may be transmitted from another device via the network NW. A program for controlling the entire first server 100 may be stored in the first storage unit 140 as a program different from the first control program CPG1.

The first storage unit 140 stores various programs executed by the first controller 120, various kinds of data processed by the first controller 120, and the like. The first storage unit 140 is an example of a first storage device. The first storage unit 140 includes a semiconductor memory of one or both of a volatile memory such as a random-access memory (RAM), and a nonvolatile memory such as a read-only memory (ROM), an electrically erasable programmable read-only memory (EEPROM) or a programmable ROM (PROM). A part or all of the first storage unit 140 may be provided in the first controller 120.

For example, any information processing device can be adopted as the second server 200. For example, the second server 200 is an information processing device that manages a web application executed in response to a request from the terminal device 300. In the embodiment, it is assumed that one of the first program PG1 and the second program PG2 is stored in a second storage unit 240 to be described later as a web application. FIG. 1 shows a case where the first program PG1 is stored in the second storage unit 240 as a web application.

The second server 200 includes, for example, a second controller 220, the second storage unit 240, and a second communication unit 260 that is hardware for communicating with other devices such as the first server 100. The second communication unit 260 performs communication by a wired method or a wireless method. The second communication unit 260 is implemented in a similar manner to the first communication unit 160. The second communication unit 260 is an example of a second communication device.

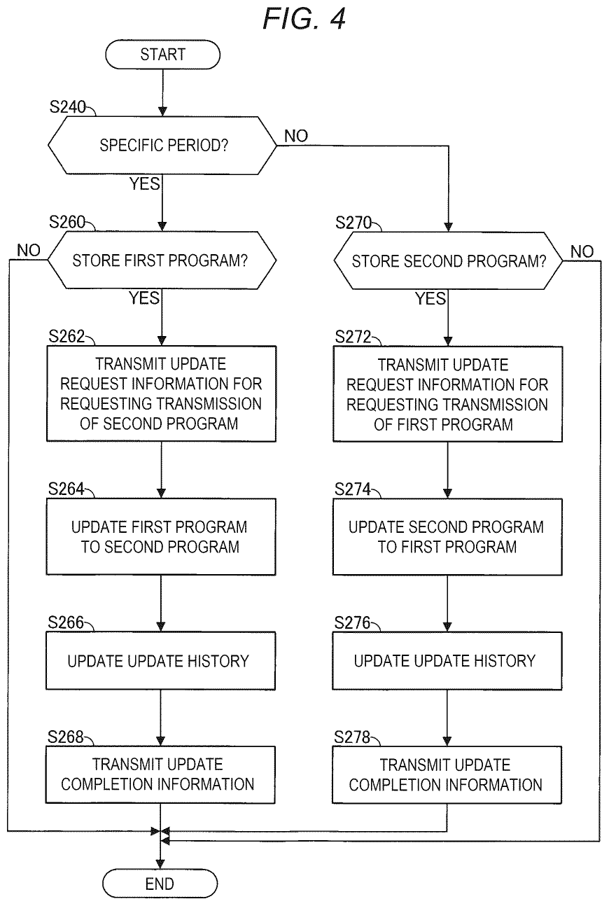

The second controller 220 is implemented in a similar manner to the first controller 120 of the first server 100 described above. The second controller 220 is an example of a second control device. For example, the second controller 220 executes the second control program CPG2 stored in the second storage unit 240 and operates according to the second control program CPG2 to control the entire second server 200. The second controller 220 has a function of executing a web application in response to a request from the terminal device 300 by executing the second control program CPG2. An operation of the second controller 220 and the like when the second controller 220 executes the second control program CPG2 will be described with reference to FIGS. 2 and 4. The second control program CPG2 may be transmitted from another device via the network NW. A program for controlling the entire second server 200 may be stored in the second storage unit 240 as a program different from the second control program CPG2.

The second storage unit 240 is implemented in a similar manner to the first storage unit 140 of the first server 100 described above. The second storage unit 240 is an example of a second storage device. For example, the second storage unit 240 stores various programs executed by the second controller 220, various kinds of data processed by the second controller 220, and the like.

For example, any information processing device can be adopted as the terminal device 300. For example, the terminal device 300 may be a stationary information device such as a personal computer, or may be a portable information terminal such as a smartphone, a notebook computer, a wearable terminal, or a tablet terminal. In the embodiment, it is assumed that the terminal device 300 is a smartphone. For example, the terminal device 300 requests the second server 200 to execute the web application.

The terminal device 300 includes, for example, a third controller 320, a third storage unit 340, a third communication unit 360 that is hardware for communicating with other devices such as the second server 200, and a display unit 380. The third communication unit 360 performs communication by a wired method or a wireless method. The third communication unit 360 may be implemented in a similar manner to the first communication unit 160. The third communication unit 360 is an example of a third communication device.

The third controller 320 is implemented in a similar manner to the first controller 120 of the first server 100 described above. The third controller 320 is an example of a third control device. For example, the third controller 320 executes a third control program CPG3 stored in the third storage unit 340 and operates according to the third control program CPG3 to control the entire terminal device 300. The third controller 320 has a function of requesting the second server 200 to execute a web application by executing a terminal program TPG stored in the third storage unit 340. An operation of the third controller 320 and the like when the third controller 320 executes the terminal program TPG will be described with reference to FIG. 2. The third control program CPG3 and the terminal program TPG may be transmitted from another device via the network NW. The third control program CPG3 may include the terminal program TPG.

The third storage unit 340 is implemented in a similar manner to the first storage unit 140 of the first server 100 described above. The third storage unit 340 is an example of a third storage device. For example, the third storage unit 340 stores various programs executed by the third controller 320, various kinds of data processed by the third controller 320, and the like.

The display unit 380 is an output device such as a display that outputs information to the outside. For example, the display unit 380 displays an image under the control of the third controller 320. The display unit 380 is an example of a display device. For example, various display panels such as a liquid crystal display panel and an organic electro luminescence (EL) display panel are suitably used as the display unit 380. In the embodiment, it is assumed that the display unit 380 also functions as an input device that receives an input from the outside. That is, in the embodiment, it is assumed that the display unit 380 has a configuration in which an input device and an output device are integrated, for example, the display unit 380 is a touch panel.

The configuration of the information processing system 10 is not limited to the example shown in FIG. 1. For example, a network connecting the first server 100 and the second server 200 may be a network different from a network connecting the second server 200 and the terminal device 300. For example, each of the first server 100 and the second server 200 may include at least one of an input device and an output device. The terminal device 300 may include an input device separate from an output device.

An example of an operation of the information processing system 10 will be described below with reference to FIG. 2.

FIG. 2 is a diagram showing an example of the operation of the information processing system 10 according to the first embodiment. In FIG. 2, it is assumed that an emergency occurs at a timing indicated by an asterisk shown in FIG. 2. That is, the asterisk in FIG. 2 indicates the start of the specific period.

In the embodiment, it is assumed that authentication is necessary for the first server 100 to access the second server 200. For example, the second server 200 stores authentication information necessary for authenticating the first server 100 in the second storage unit 240. When the authentication information acquired from the first server 100 is correct, the second server 200 permits the first server 100 to access the second server 200. In the example shown in FIG. 2, it is assumed that authentication for the first server 100 to access the second server 200, for example, login to the second server 200 is completed before processing of step S120 is executed. In the embodiment, it is assumed that the third controller 320 of the terminal device 300 executes the terminal program TPG so that the terminal device 300 can access the second server 200.

First, in step S100, the first controller 120 of the first server 100 stores the first program PG1 and the second program PG2 in the first storage unit 140. Next, in step S120, the first controller 120 transmits the first program PG1 to the second server 200 via the first communication unit 160.

After the processing of step S120 is executed, the second server 200 receives the first program PG1. Then, in step S200, the second controller 220 of the second server 200 stores the first program PG1 in the second storage unit 240 as a web application executed in response to a request from the terminal device 300.

Here, a series of processing from step S100 to step S200 corresponds to, for example, initial processing for enabling the web application provided by the first server 100 to be used via the network NW. The initial processing is executed, for example, not only when the first program PG1 is newly created but also when content of the first program PG1 is changed. After the initial processing is completed, for example, processing of step S240 is executed.

For example, in step S240, the second controller 220 of the second server 200 determines whether a current time point is in the specific period. Specifically, for example, the second controller 220 may determine whether it is the specific period based on information such as breaking news for notifying the occurrence of a specific event such as an emergency. Alternatively, the second controller 220 may determine whether it is the specific period based on a notification from an operator of the second server 200. The notification from the operator of the second server 200 is implemented by, for example, the operator inputting information indicating that a specific event such as an emergency occurs or information indicating that the specific period ends to the second server 200.

When the first program PG1 is stored in the second storage unit 240 as the web application, the determination of whether the current time point is in the specific period corresponds to determination of whether to update the first program PG1 stored in the second storage unit 240 to the second program PG2. In FIG. 2, as described above, the determination in step S240 is executed after the specific period is started. Therefore, a determination result in step S240 is positive. That is, in FIG. 2, the second controller 220 determines to update the first program PG1 to the second program PG2 in step S240. Therefore, in step S262, the second controller 220 transmits, to the first server 100 via the second communication unit 260, update request information REQu for requesting to update the first program PG1 to the second program PG2.

After the processing of step S262 is executed, the first server 100 receives the update request information REQu for requesting to update the first program PG1 to the second program PG2. Therefore, in step S160, the first controller 120 of the first server 100 transmits the second program PG2 to the second server 200 via the first communication unit 160.

After the processing of step S160 is executed, the second server 200 receives the second program PG2. Then, in step S264, the second controller 220 of the second server 200 updates the first program PG1 to the second program PG2. Specifically, the second controller 220 stores the second program PG2 in the second storage unit 240 as a web application. For example, the second controller 220 replaces the first program PG1 stored in the second storage unit 240 with the second program PG2.

Next, in step S266, the second controller 220 updates an update history of the web application. Then, in step S268, the second controller 220 transmits, to the first server 100 via the second communication unit 260, update completion information Cinf indicating that the update of the web application is completed. In the example shown in FIG. 2, the update completion information Cinf indicates that the web application is updated from the first program PG1 to the second program PG2.

After the processing of step S268 is executed, the first server 100 receives the update completion information Cinf. Then, in step S180, the first controller 120 of the first server 100 updates an update history of the web application.

In step S300, the third controller 320 of the terminal device 300 transmits, to the second server 200 via the third communication unit 360, execution request information REQe for requesting execution of the web application. For example, the third controller 320 may execute the terminal program TPG to cause the display unit 380 to display an operation icon or the like for requesting execution of the web application. Then, the third controller 320 may transmit the execution request information REQe to the second server 200 via the third communication unit 360 when the operation icon for requesting execution of the web application is selected.

After the processing of step S300 is executed, the second server 200 receives the execution request information REQe. Then, in step S280, the second controller 220 of the second server 200 executes the second program PG2 stored in the second storage unit 240 as a web application. In FIG. 2, since the processing of step S300 is executed after the specific period is started, the second program PG2 is executed as the web application as described above.

Next, in step S282, the second controller 220 transmits, as result information indicating an execution result of the web application, result information Rinf indicating an execution result of the second program PG2 to the terminal device 300 via the second communication unit 260.

After the processing of step S282 is executed, the terminal device 300 receives the result information Rinf. Then, in step S340, the third controller 320 of the terminal device 300 causes the display unit 380 to display the execution result of the second program PG2 as the execution result of the web application based on the result information Rinf.

As described above, in the embodiment, it is possible to update the web application, for example, update the first program PG1 to the second program PG2 without updating the terminal program TPG stored in the third storage unit 340 of the terminal device 300. That is, in the embodiment, when a specific event occurs, a specific function of the first program PG1 can be quickly restricted. In the embodiment, the web application can be updated without communicating between the terminal device 300 and the second server 200. Therefore, in the embodiment, it is possible to prevent an increase in communication processing between the terminal device 300 and the second server 200 when the web application is updated.

Although FIG. 2 shows a case where the processing of step S300 is executed in the specific period, when the processing of step S300 is executed in the normal period, the first program PG1 is stored in the second storage unit 240 of the second server 200 as the web application. Therefore, when the processing of step S300 is executed in the normal period, for example, the second controller 220 of the second server 200 omits step S262 to step S268 and executes the first program PG1 stored in the second storage unit 240 as the web application in step S280. Then, in step S282, the second controller 220 transmits, as result information indicating an execution result of the web application, result information Rinf indicating an execution result of the first program PG1 to the terminal device 300 via the second communication unit 260. Therefore, when the processing of step S300 is executed in the normal period, the third controller 320 of the terminal device 300 causes the display unit 380 to display the execution result of the first program PG1 as the execution result of the web application based on the result information Rinf in step S340.

The operation of the information processing system 10 is not limited to the example shown in FIG. 2. For example, the processing of steps S240 and S262 executed by the second server 200 may be omitted, and the first controller 120 of the first server 100 may execute the same processing as the processing of step S240. For example, in this aspect, after executing a series of processing of steps S100 and S120, the first controller 120 determines whether a current time point is in the specific period. When it is determined that the current time point is in the specific period, the first controller 120 transmits the second program PG2 to the second server 200 via the first communication unit 160 in step S160.

Next, an example of an operation of the first server 100 will be described with reference to FIG. 3.

FIG. 3 is a flowchart showing an example of the operation of the first server 100 according to the first embodiment. FIG. 3 shows the operation of the first server 100 after the initial processing described in FIG. 2 is completed. That is, the processing of steps S100 and S120 shown in FIG. 2 is executed before processing of step S140 is executed. Detailed description of processing similar to the processing described in FIG. 2 will be omitted.

First, in step S140, the first controller 120 determines whether the first communication unit 160 receives, from the second server 200, the update request information REQu for requesting to update the web application to the second program PG2. When the first controller 120 determines that the first communication unit 160 receives, from the second server 200, the update request information REQu for requesting to update the web application to the second program PG2, that is, when a determination result in step S140 is positive (step S140/YES), the first controller 120 proceeds the processing to step S142. On the other hand, when the first controller 120 determines that the first communication unit 160 does not receive the update request information REQu for requesting to update the web application to the second program PG2 from the second server 200, that is, when the determination result in step S140 is negative (step S140/NO), the first controller 120 ends the operation shown in FIG. 3.

In step S142, the first controller 120 determines whether to update the web application from the first program PG1 to the second program PG2 based on the update request information REQu. For example, when the update request information REQu is information for requesting transmission of the second program PG2, a determination result in step S142 is positive. When the update request information REQu is information for requesting transmission of the first program PG1, the determination result in step S142 is negative. The update request information REQu is information for requesting transmission of either the first program PG1 or the second program PG2.

When the first controller 120 determines to update the web application from the first program PG1 to the second program PG2, that is, when the determination result in step S142 is positive (step S142/YES), the first controller 120 transmits the second program PG2 to the second server 200 via the first communication unit 160 in step S160.

On the other hand, when the first controller 120 determines not to update the web application from the first program PG1 to the second program PG2, that is, when the determination result in step S142 is negative (step S142/NO), the first controller 120 transmits the first program PG1 to the second server 200 via the first communication unit 160 in step S162.

After executing the processing of step S160 or S162, the first controller 120 proceeds the processing to step S180.

In step S180, the first controller 120 updates an update history of the web application. For example, as described with reference to FIG. 2, the first controller 120 updates the update history of the web application based on the update completion information Cinf transmitted from the second server 200.

As described above, in the embodiment, a series of processing from step S142 to step S180 is executed each time the first communication unit 160 receives the update request information REQu from the second server 200 after the initial processing described with reference to FIG. 2 is completed.

The operation of the first server 100 is not limited to the example shown in FIG. 3. For example, the processing of step S140 and the processing of step S142 may not be strictly distinguished from each other.

Next, an example of an operation of the second server 200 will be described with reference to FIG. 4.

FIG. 4 is a flowchart showing an example of the operation of the second server 200 according to the first embodiment. FIG. 4 shows the operation of the second server 200 after the initial processing described in FIG. 2 is completed. That is, the processing of step S200 shown in FIG. 2 is executed before the processing of step S240 is executed. Detailed description of processing similar to the processing described in FIG. 2 will be omitted.

First, in step S240, the second controller 220 determines whether a current time point is in the specific period. When it is determined that the current time point is in the specific period, that is, a current date and time is included in the specific period, that is, when a determination result in step S240 is positive (step S240/YES), the second controller 220 proceeds the processing to step S260. On the other hand, when the second controller 220 determines that the current time point is not in the specific period, that is, when the determination result in step S240 is negative (step S240/NO), the second controller 220 proceeds the processing to step S270.

In step S260, the second controller 220 determines whether the first program PG1 is stored in the second storage unit 240. That is, the second controller 220 determines whether the first program PG1 is stored in the second storage unit 240 as the web application. When the second controller 220 determines that the first program PG1 is stored in the second storage unit 240, that is, when a determination result in step S260 is positive (step S260/YES), the second controller 220 proceeds the processing to step S262. On the other hand, when it is determined that the first program PG1 is not stored in the second storage unit 240, that is, when the determination result in step S260 is negative (step S260/NO), the second controller 220 ends the operation shown in FIG. 4. Step S260 may constitute processing of determining whether to update the first program PG1 to the second program PG2 together with step S240.

In step S262, the second controller 220 transmits, to the first server 100 via the second communication unit 260, the update request information REQu for requesting transmission of the second program PG2. That is, the second controller 220 transmits the update request information REQu for requesting to update the first program PG1 to the second program PG2 to the first server 100 via the second communication unit 260. As described above, when the specific period is started in a state where the first program PG1 is stored in the second storage unit 240 as the web application, the update request information REQu for requesting transmission of the second program PG2 is transmitted to the first server 100.

Next, in step S264, the second controller 220 updates the first program PG1 to the second program PG2. For example, as described with reference to FIG. 2, the second controller 220 updates the first program PG1 to the second program PG2 by replacing the first program PG1 stored in the second storage unit 240 with the second program PG2 transmitted from the first server 100.

Then, in step S266, the second controller 220 updates the update history of the web application.

Next, in step S268, the second controller 220 transmits the update completion information Cinf indicating that the update from the first program PG1 to the second program PG2 is completed to the first server 100 via the second communication unit 260.

In step S270, the second controller 220 determines whether the second program PG2 is stored in the second storage unit 240. That is, the second controller 220 determines whether the second program PG2 is stored in the second storage unit 240 as the web application. When the second controller 220 determines that the second program PG2 is stored in the second storage unit 240, that is, when a determination result in step S270 is positive (step S270/YES), the second controller 220 proceeds the processing to step S272. On the other hand, when the second controller 220 determines that the second program PG2 is not stored in the second storage unit 240, that is, when the determination result in step S270 is negative (step S270/NO), the second controller 220 ends the operation shown in FIG. 4.

In step S272, the second controller 220 sends the update request information REQu for requesting transmission of the first program PG1 to the first server 100 via the second communication unit 260. That is, the second controller 220 transmits the update request information REQu for requesting to update the second program PG2 to the first program PG1 to the first server 100 via the second communication unit 260. As described above, when the specific period ends in a state where the second program PG2 is stored in the second storage unit 240 as the web application, the update request information REQu for requesting transmission of the first program PG1 is transmitted to the first server 100.

Next, in step S274, the second controller 220 updates the second program PG2 to the first program PG1. For example, the second controller 220 updates the second program PG2 to the first program PG1 by replacing the second program PG2 stored in the second storage unit 240 with the first program PG1 transmitted from the first server 100.

Then, in step S276, the second controller 220 updates the update history of the web application.

Next, in step S278, the second controller 220 transmits the update completion information Cinf indicating that the update from the second program PG2 to the first program PG1 is completed to the first server 100 via the second communication unit 260.

When the processing of step S268 or S278 ends, the operation shown in FIG. 4 ends.

As described above, when the specific period is started in a state where the first program PG1 is stored in the second storage unit 240 as the web application, a series of processing from step S262 to step S268 is executed. Accordingly, the web application is updated from the first program PG1 to the second program PG2. When the specific period ends in a state where the second program PG2 is stored in the second storage unit 240 as the web application, a series of processing from step S272 to step S278 is executed. Accordingly, the web application is updated from the second program PG2 to the first program PG1.

The operation of the second server 200 is not limited to the example shown in FIG. 4. For example, the second controller 220 may return the processing to step S240 after the processing of step S268 or S278 is executed.

As described above, in the embodiment, the information processing system 10 includes the first server 100 provided with the first controller 120, the first storage unit 140, and the first communication unit 160, the second server 200 provided with the second controller 220, the second storage unit 240, and the second communication unit 260, and the terminal device 300 provided with the third controller 320, the third communication unit 360, and the display unit 380. The first storage unit 140 stores the first program PG1 and the second program PG2 in which a part of functions of the first program PG1 is restricted. The second storage unit 240 stores one of the first program PG1 and the second program PG2 as the web application executed in response to a request from the terminal device 300. When the first communication unit 160 receives, from the second server 200, the update request information REQu for requesting to update the first program PG1 to the second program PG2, the first controller 120 transmits the second program PG2 to the second server 200 via the first communication unit 160. When the second communication unit 260 receives the execution request information REQe for requesting the execution of the web application from the terminal device 300, the second controller 220 executes the web application stored in the second storage unit 240 and transmits the result information Rinf indicating the execution result of the web application to the terminal device 300 via the second communication unit 260. The second controller 220 determines whether to update the first program PG1 stored in the second storage unit 240 as a web application to the second program PG2, when it is determined to update the first program PG1 to the second program PG2, the second controller 220 transmits the update request information REQu to the first server 100 via the second communication unit 260, and when the second communication unit 260 receives the second program PG2 from the first server 100, the second controller 220 updates the first program PG1 to the second program PG2 transmitted from the first server 100. When the third controller 320 transmits the execution request information REQe to the second server 200 via the third communication unit 360, and the third communication unit 360 receives the result information Rinf from the second server 200, the third controller 320 causes the display unit 380 to display the execution result of the web application based on the result information Rinf.

In the program update method according to the embodiment, the second server 200 capable of communicating with the first server 100 and the terminal device 300 stores the first program PG1 as the web application executed in response to a request from the terminal device 300, the second server 200 determines whether to update the first program PG1 to the second program PG2 in which a part of functions of the first program PG1 is restricted, when it is determined to update the first program PG1 to the second program PG2, the second server 200 transmits the update request information REQu for requesting to update the first program PG1 to the second program PG2 to the first server 100, the first server 100 transmits the second program PG2 to the second server 200 based on the update request information REQu, and the second server 200 updates the first program PG1 to the second program PG2.

As described above, in the embodiment, the second server 200 updates the web application and executes the web application in response to the execution request information REQe from the terminal device 300. As a result, in the embodiment, the first program PG1 can be updated to the second program without determining whether to update the program by a user of the terminal device 300. That is, in the embodiment, it is possible to prevent the update from the first program PG1 to the second program from being delayed depending on determination of a user. As a result, in the embodiment, when a specific event such as an emergency occurs, a specific function of the first program PG1 can be quickly restricted.

### 2. Second Embodiment

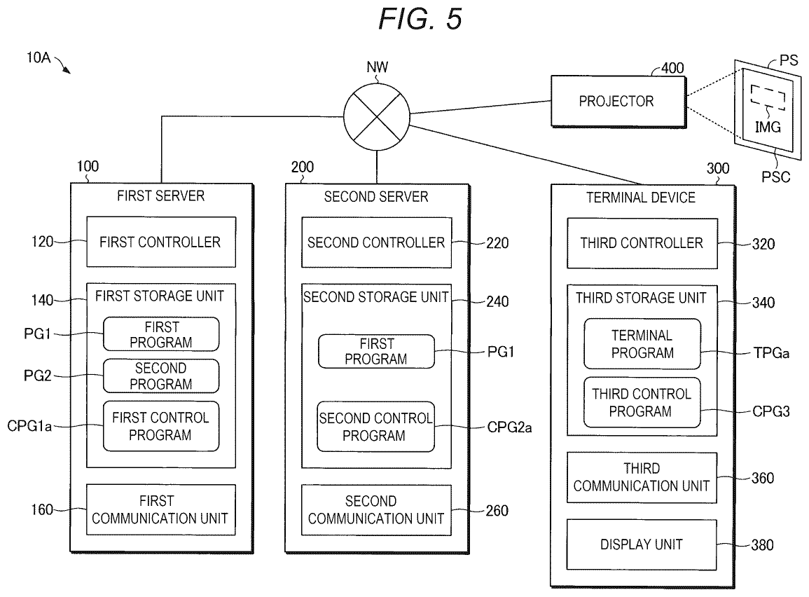

Next, an overview of an information processing system 10A according to a second embodiment will be described with reference to FIG. 5.

FIG. 5 is a diagram showing an example of the information processing system 10A according to the second embodiment. The same elements as the elements described in FIGS. 1 to 4 are denoted by the same reference numerals, and detailed description thereof will be omitted. The information processing system 10A shown in FIG. 5 is similar to the information processing system 10 shown in FIG. 1 except that the information processing system 10A includes a projector 400. The projector 400 is connected to, for example, the network NW. In the embodiment, it is assumed that the projector 400 can communicate with the first server 100 and the terminal device 300.

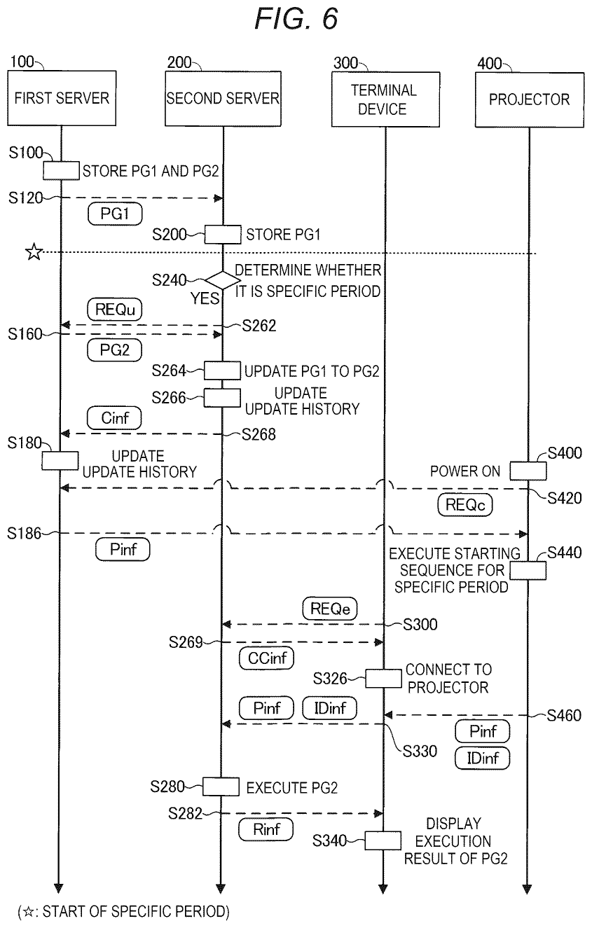

The first server 100 shown in FIG. 5 is similar to the first server 100 shown in FIG. 1. For example, the first server 100 includes the first controller 120, the first storage unit 140, and the first communication unit 160. However, the first server 100 shown in FIG. 5 is different from the first server 100 shown in FIG. 1 in that a first control program CPG1a is stored in the first storage unit 140 instead of the first control program CPG1 and the first controller 120 executes the first control program CPG1a. An operation of the first server 100 when the first controller 120 executes the first control program CPG1a will be described with reference to FIG. 6.

The second server 200 shown in FIG. 5 is similar to the second server 200 shown in FIG. 1. For example, the second server 200 includes the second controller 220, the second storage unit 240, and the second communication unit 260. However, the second server 200 shown in FIG. 5 is different from the second server 200 shown in FIG. 1 in that a second control program CPG2a is stored in the second storage unit 240 instead of the second control program CPG2 and the second controller 220 executes the second control program CPG2a. An operation of the second server 200 when the second controller 220 executes the second control program CPG2a will be described with reference to FIG. 6.

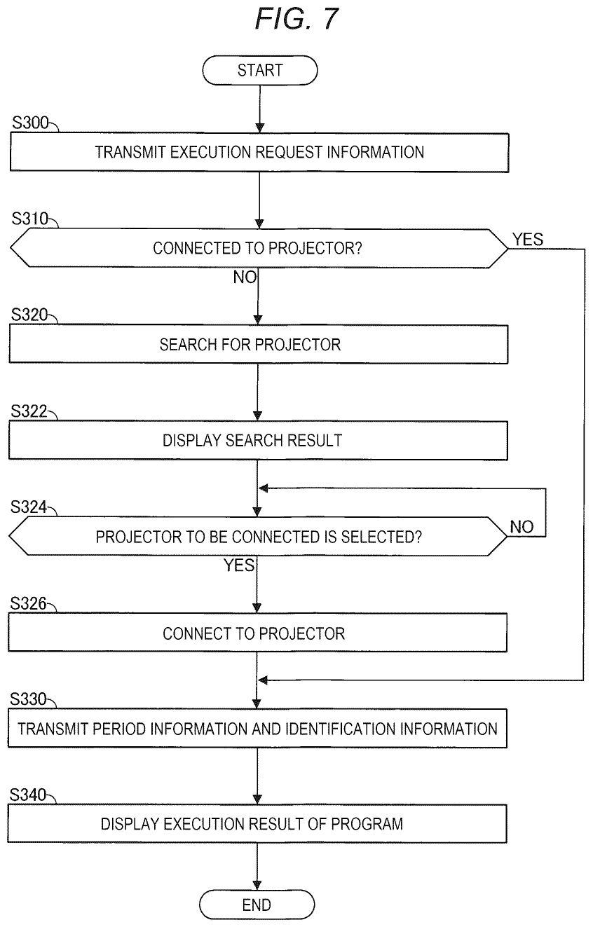

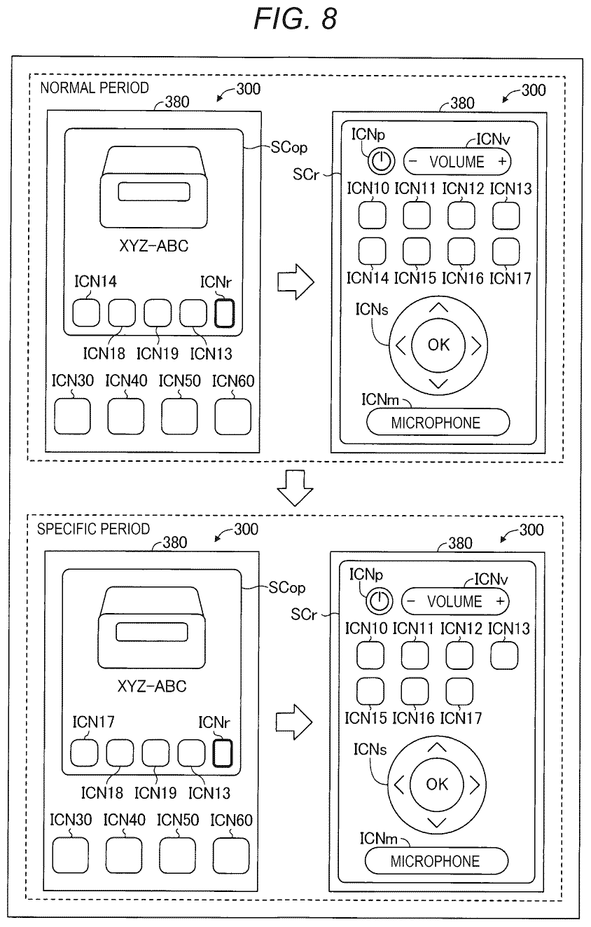

The terminal device 300 shown in FIG. 5 is similar to the terminal device 300 shown in FIG. 1. For example, the terminal device 300 includes the third controller 320, the third storage unit 340, the third communication unit 360, and the display unit 380. However, the terminal device 300 shown in FIG. 5 is different from the terminal device 300 shown in FIG. 1 in that a terminal program TPGa is stored in the third storage unit 340 instead of the terminal program TPG and the third controller 320 executes the terminal program TPGa. An operation of the terminal device 300 when the third controller 320 executes the terminal program TPGa will be described with reference to FIGS. 6 and 7. In the embodiment, the terminal device 300 functions as an operation device for operating the projector 400 by displaying an execution result of the web application on the display unit 380. An example of a screen displayed on the display unit 380 of the terminal device 300 as the execution result of the web application will be described with reference to FIG. 8.

The projector 400 displays a display screen PSC on a projection surface PS by, for example, projecting light based on frame data representing the display screen PSC on the projection surface PS such as a screen. The projector 400 is an example of a “display device”, and the display screen PSC is an example of a “first screen”. In the embodiment, it is assumed that the display screen PSC that can be presented by the projector 400 is displayed on the projection surface PS. For example, the projector 400 projects light based on frame data and image data onto the projection surface PS to display the display screen PSC including an image IMG represented by the image data on the projection surface PS. The presentation of the display screen PSC includes, for example, decorating a frame of the display screen PSC and decorating the background of the image IMG. The presentation of the display screen PSC is not limited to the example described above.

The projector 400 includes an optical system device (not shown) that projects light. Although not shown in FIG. 5, the projector 400 includes, for example, a controller, a storage unit, and a communication unit that are respectively implemented in a similar manner to the first controller 120, the first storage unit 140, and the first communication unit 160 of the first server 100.

Here, in the embodiment, it is assumed that the first program PG1 is a web application having a first function of causing the projector 400 to display the display screen PSC and a second function of presenting the display screen PSC. Further, in the embodiment, it is assumed that the second program is a web application in which the second function of the functions of the first program PG1 is restricted. Therefore, in the embodiment, only the second function of presenting the display screen PSC can be restricted in the specific period. Accordingly, in the embodiment, a user can use the projector 400 even in the specific period. The second function is, for example, a “part function of the first program”. When the first program PG1 has a plurality of functions, the second function may be at least one function of the plurality of functions. The second function may be a part of one function of the functions of the first program PG1.

The display device is not limited to the projector 400. The display device may be, for example, a display such as a flat panel display (FPD). The FPD is, for example, a liquid crystal display, a plasma display, or an organic electro luminescence (EL) display.

An example of an operation of the information processing system 10A will be described below with reference to FIG. 6.

FIG. 6 is a diagram showing an example of the operation of the information processing system 10A according to the second embodiment. The same operations as those described in FIG. 2 are denoted by the same reference numerals, and detailed description thereof will be omitted. An asterisk in FIG. 6 is the same as the asterisk in FIG. 2.

A series of processing from step S100 to step S180 shown in FIG. 6 is similar to the series of processing from step S100 to step S180 shown in FIG. 2. A series of processing from step S200 to step S268 shown in FIG. 6 is similar to the series of processing from step S200 to step S268 shown in FIG. 2. In FIG. 6, it is assumed that processing of step S400 is executed after the processing of step S180.

In step S400, the projector 400 is powered on in response to an operation of turning on a power supply of the projector 400 by a user of the terminal device 300 or the projector 400. Then, in step S420, the projector 400 transmits confirmation request information REQc for confirming whether a period in which the web application is executed is the specific period to the first server 100.

After the processing of step S420 is executed, the first server 100 receives the confirmation request information REQc. Then, in step S186, the first controller 120 of the first server 100 transmits period information Pinf indicating whether the period in which the web application is executed is the specific period to the projector 400 via the first communication unit 160. For example, the first controller 120 may specify whether the period in which the web application is executed is the specific period based on an update history of the web application, or may inquire of the second server 200 about whether the period in which the web application is executed is the specific period. Alternatively, the first controller 120 may specify whether the period in which the web application is executed is the specific period by determining whether a current time point is in the specific period by processing similar to the processing of step S240.

After the processing of step S186 is executed, the projector 400 receives the period information Pinf. In the example shown in FIG. 6, a timing at which the projector 400 is powered on is in the specific period. Therefore, the period information Pinf received by the projector 400 from the first server 100 indicates that the period in which the web application is executed is the specific period. Therefore, the projector 400 executes a starting sequence for the specific period in step S440. In the embodiment, it is assumed that the starting sequence for the specific period is different from a starting sequence for the normal period. For example, the projector 400 that executes the starting sequence for the specific period does not receive a command for executing the second function of presenting the display screen PSC.

In step S300, the third controller 320 of the terminal device 300 transmits execution request information REQe for requesting execution of the web application to the second server 200 via the third communication unit 360.

After the processing of step S300 is executed, the second server 200 receives the execution request information REQe. Then, in step S269, the second controller 220 of the second server 200 transmits, to the terminal device 300 via the second communication unit 260, connection confirmation information CCinf for confirming whether the terminal device 300 is connected to the projector 400.

After the processing of step S269 is executed, the terminal device 300 receives the connection confirmation information CCinf. In FIG. 6, it is assumed that the terminal device 300 is not connected to the projector 400. Therefore, the third controller 320 of the terminal device 300 is connected to the projector 400 via the third communication unit 360 in step S326. In step S460, the projector 400 connected to the terminal device 300 transmits the period information Pinf and identification information IDinf for identifying the projector 400 to the terminal device 300.

After the processing of step S460 is executed, the terminal device 300 receives the period information Pinf and the identification information IDinf of the projector 400. Then, in step S330, the third controller 320 of the terminal device 300 transmits the period information Pinf and the identification information IDinf of the projector 400 to the second server 200 via the third communication unit 360.

After the processing of step S330 is executed, the second server 200 receives the period information Pinf and the identification information IDinf of the projector 400. Accordingly, the second server 200 recognizes that the projector 400 indicated by the identification information IDinf and the terminal device 300 are connected. Then, in step S280, the second controller 220 of the second server 200 executes the second program PG2 stored in the second storage unit 240 as a web application. Next, in step S282, the second controller 220 transmits, as result information indicating an execution result of the web application, result information Rinf indicating an execution result of the second program PG2 to the terminal device 300 via the second communication unit 260.

After the processing of step S282 is executed, the terminal device 300 receives the result information Rinf. Then, in step S340, the third controller 320 of the terminal device 300 causes the display unit 380 to display the execution result of the second program PG2 as the execution result of the web application based on the result information Rinf.

As described above, in the embodiment, the first program PG1 can be updated to the second program PG2 without updating the terminal program TPGa stored in the third storage unit 340 of the terminal device 300 in a similar manner to the first embodiment described above. That is, in the embodiment, when a specific event occurs, a specific function of the first program PG1 can be quickly restricted. Further, in the embodiment, when the projector 400 is powered on in the specific period in which the specific event occurs, the starting sequence for the specific period is executed, so that a specific function of the projector 400 can be quickly restricted.

Although FIG. 6 shows a case where the processing of step S300 is executed in the specific period in a similar manner to that shown in FIG. 2, when the processing of step S300 is executed in the normal period, the first program PG1 is stored in the second storage unit 240 of the second server 200 as the web application. Therefore, when the processing of step S300 is executed in the normal period, for example, the second controller 220 of the second server 200 omits step S262 to step S268 and executes the first program PG1 stored in the second storage unit 240 as the web application in step S280. Then, in step S282, the second controller 220 transmits, as result information indicating an execution result of the web application, result information Rinf indicating an execution result of the first program PG1 to the terminal device 300 via the second communication unit 260. Therefore, when the processing of step S300 is executed in the normal period, the third controller 320 of the terminal device 300 causes the display unit 380 to display the execution result of the first program PG1 as the execution result of the web application based on the result information Rinf in step S340.

The operation of the information processing system 10A is not limited to the example shown in FIG. 6. For example, the processing of steps S240 and S262 executed by the second server 200 may be omitted, and the first controller 120 of the first server 100 may execute the same processing as the processing of step S240. For example, in this aspect, after executing a series of processing of steps S100 and S120, the first controller 120 may determine whether a current time point is in the specific period. When it is determined that the current time point is in the specific period, the first controller 120 transmits the second program PG2 to the second server 200 via the first communication unit 160 in step S160. The first server 100 may include, for example, an information processing device that executes a series of processing from step S100 to step S180 and an information processing device that executes processing for the projector 400 such as step S186.

Next, an example of an operation of the terminal device 300 will be described with reference to FIG. 7.

FIG. 7 is a flowchart showing an example of the operation of the terminal device 300 according to the second embodiment. Detailed description of processing similar to the processing described in FIG. 6 will be omitted.

First, in step S300, the third controller 320 transmits execution request information REQe for requesting execution of a web application to the second server 200 via the third communication unit 360.

Next, in step S310, the third controller 320 determines whether the terminal device 300 is already connected to the projector 400. When it is determined that the terminal device 300 is already connected to the projector 400, that is, when a determination result in step S310 is positive (step S310/YES), the third controller 320 proceeds the processing to step S330. On the other hand, when the third controller 320 determines that the terminal device 300 is not connected to the projector 400, that is, when the determination result in step S310 is negative (step S310/NO), the third controller 320 proceeds the processing to step S320.

In step S320, the third controller 320 searches for the projector 400 that can be connected to the terminal device 300.

Then, in step S322, the third controller 320 causes the display unit 380 to display a search result such as a list of the projectors 400 that can be connected to the terminal device 300.

Next, in step S324, the third controller 320 determines whether the projector 400 connected to the terminal device 300 is selected. For example, when an operation of selecting the projector 400 connected to the terminal device 300 is performed by a user, the third controller 320 determines that the projector 400 connected to the terminal device 300 is selected. When it is determined that the projector 400 connected to the terminal device 300 is selected, that is, when a determination result in step S324 is positive (step S324/YES), the third controller 320 proceeds the processing to step S326. On the other hand, when it is determined that the projector 400 connected to the terminal device 300 is not selected, that is, when the determination result in step S324 is negative (step S324/NO), the third controller 320 returns the processing to step S324.

In step S326, the third controller 320 connects the terminal device 300 and the projector 400 using the third communication unit 360. Accordingly, the projector 400 selected by the user is connected to the terminal device 300. After executing the processing of step S326, the third controller 320 proceeds the processing to step S330.

In step S330, the third controller 320 transmits the period information Pinf and the identification information IDinf of the projector 400 to the second server 200 via the third communication unit 360. The period information Pinf and the identification information IDinf of the projector 400 are transmitted from the projector 400 connected to the terminal device 300 to the terminal device 300 as described with reference to FIG. 6. Therefore, in step S330, the third controller 320 transmits the period information Pinf and the identification information IDinf of the projector 400 transmitted from the projector 400 connected to the terminal device 300 to the second server 200 via the third communication unit 360.

Next, in step S340, the third controller 320 causes the display unit 380 to display the execution result of the web application based on the result information Rinf received from the second server 200. For example, as described in FIG. 6, since the second program PG2 is executed as the web application in the specific period, an execution result of the second program PG2 is displayed on the display unit 380. Since the first program PG1 is executed as the web application in the normal period, the execution result of the first program PG1 is displayed on the display unit 380.

The operation of the terminal device 300 is not limited to the example shown in FIG. 7. For example, in step S330, the third controller 320 may transmit only the identification information IDinf between the period information Pinf and the identification information IDinf of the projector 400 to the second server 200 via the third communication unit 360. Alternatively, in step S330, the third controller 320 may transmit information indicating that the terminal device 300 and the projector 400 are connected.

Next, an example of a screen displayed as an execution result of the web application on the display unit 380 of the terminal device 300 will be described with reference to FIG. 8.

FIG. 8 is a diagram showing an example of a screen displayed on the terminal device 300 as an execution result of the web application. An upper part of FIG. 8 shows an example of an operation screen SCop and a remote-control screen SCr displayed on the display unit 380 of the terminal device 300 when the first program PG1 is executed. That is, the upper part of FIG. 8 shows an example of the operation screen SCop and the remote-control screen SCr in the normal period. A lower part of FIG. 8 shows an example of an operation screen SCop and a remote-control screen SCr displayed on the display unit 380 of the terminal device 300 when the second program PG2 is executed. That is, the lower part of FIG. 8 shows an example of the operation screen SCop and the remote-control screen SCr in the specific period. The operation screen SCop and the remote-control screen SCr are examples of an “execution result screen”.

For example, the operation screen SCop is displayed on the display unit 380 as an execution result of the web application executed in response to the execution request information REQe. The operation screen SCop shown in FIG. 8 corresponds to a home screen of the web application when the first program PG1 or the second program PG2 is executed as the web application. In the example shown in FIG. 8, in addition to the operation screen SCop, a plurality of icons ICN30, ICN40, ICN50, and ICN60 associated with a plurality of pieces of processing related to control of the terminal device 300 are displayed on the display unit 380 on which the operation screen SCop is displayed. Hereinafter, the plurality of icons ICN30, ICN40, ICN50, ICN60, and the like may be collectively referred to as an icon ICN. FIG. 8 shows a case where four icons ICN are displayed on the display unit 380 in addition to the operation screen SCop, but the number of the icons ICN displayed on the display unit 380 is not limited to the example shown in FIG. 8. The icon ICN displayed on the display unit 380 may be appropriately changed by a user.

First, the operation screen SCop and the remote-control screen SCr in the normal period will be described.

For example, a plurality of icons ICN14, ICN18, ICN19, ICN13, and ICNr associated with a plurality of pieces of processing related to control of the projector 400 are displayed on the operation screen SCop in the normal period.

For example, the icon ICN14 is an operation icon for presenting a display screen PSC. When the icon ICN14 is selected, for example, a presentation menu (not shown) for presenting the display screen PSC is displayed on the display unit 380. For example, the icon ICNr is a remote-control icon for displaying, on the display unit 380, the remote-control screen SCr for operating the projector 400. Therefore, when the icon ICNr is selected, the remote-control screen SCr is displayed on the display unit 380.

Although FIG. 8 shows a case where five icons ICN are displayed on the operation screen SCop, the number of the icons ICN displayed on the operation screen SCop is not limited to the example shown in FIG. 8. The icon ICN displayed on the operation screen SCop may be appropriately changed by a user.

A plurality of icons ICN for operating the projector 400 are displayed on the remote-control screen SCr in the normal period. For example, an icon ICNp is an operation icon for powering on or off the projector 400. An icon ICNv is an operation icon for adjusting a volume output from a speaker of the projector 400. The speaker of the projector 400 may be a speaker built in the projector 400 or a speaker connected to the projector 400. Alternatively, the speaker of the projector 400 may be a speaker of the terminal device 300 connected to the projector 400. An icon ICNs is an operation icon for moving and selecting a cursor or the like displayed on the projection surface PS. An icon ICNm is an operation icon for switching a microphone to be on and off.

Icons ICN10 to ICN17 are associated with various functions for operating the projector 400. For example, the icon ICN14 is an operation icon for presenting the display screen PSC as described above. Among the icons ICN10 to ICN17, the icons ICN other than the icon ICN14 are operation icons associated with functions other than the function for presenting the display screen PSC.

Next, the operation screen SCop and the remote-control screen SCr in the specific period will be described.

The operation screen SCop in the specific period is similar to the operation screen SCop in the normal period except that, for example, an icon ICN17 is displayed instead of the icon ICN14. The remote-control screen SCr in the specific period is similar to the remote-control screen SCr in the normal period except that, for example, the icon ICN14 is not displayed.

As described above, the icon ICN14 for presenting the display screen PSC is not displayed on the operation screen SCop and the remote-control screen SCr in the specific period. Therefore, in the embodiment, for example, it is possible to prevent a user from erroneously performing an operation of presenting the display screen PSC in the specific period.

Here, as described above, the operation screen SCop and the remote-control screen SCr in the specific period are the operation screen SCop and the remote-control screen SCr displayed on the display unit 380 of the terminal device 300 when the second program PG2 is executed. Therefore, the second program PG2 has a function of hiding the icon ICN14 for presenting the display screen PSC among the icons ICN displayed on the display unit 380 when the first program PG1 is executed. In this aspect, it is also possible to prevent the user from erroneously performing the operation of presenting the display screen PSC in the specific period.

The operation screen SCop and the remote-control screen SCr are not limited to the examples shown in FIG. 8. For example, the icon ICN14 may be displayed in an unselectable manner on the operation screen SCop and the remote-control screen SCr in the specific period. For example, the icon ICN14 may be grayed out and set such that the icon ICN14 is not selected even if the icon ICN14 is touched. In this case, the second program PG2 has a function of displaying, in an unselectable manner, the icon ICN14 for presenting the display screen PSC among the icons ICN displayed on the display unit 380 when the first program PG1 is executed. In this aspect, it is also possible to prevent the user from erroneously performing the operation of presenting the display screen PSC in the specific period.

Further, for example, on the remote-control screen SCr in the specific period, another icon ICN may be displayed instead of the icon ICN14, in a similar manner to the operation screen SCop in the specific period. In this case, the second program PG2 has a function of replacing, with the another icon ICN, the icon ICN14 for presenting the display screen PSC among the icons ICN displayed on the display unit 380 when the first program PG1 is executed. In this aspect, it is also possible to prevent a user from erroneously performing the operation of presenting the display screen PSC in the specific period. In this aspect, spaces on the operation screen SCop and the remote-control screen SCr can be effectively used.

For example, the operation screen SCop in the specific period may be displayed on the display unit 380 in a color different from a color of the operation screen SCop in the normal period. Similarly, the remote-control screen SCr in the specific period may be displayed on the display unit 380 in a color different from a color of the remote-control screen SCr in the normal period. Specifically, the operation screen SCop and the remote-control screen SCr in the normal period may be displayed in color, and the operation screen SCop and the remote-control screen SCr in the specific period may be displayed in black and white. In an aspect in which the operation screen SCop and the like are displayed on the display unit 380 in different colors between the specific period and the normal period, the second program PG2 has a function of displaying an execution result screen in a color different from a color of an execution result screen displayed on the display unit 380 when the first program PG1 is executed. As described above, the execution result screen is at least one of the operation screen SCop and the remote-control screen SCr. In this aspect, a user can easily determine whether the second program PG2 is executed as the web application by viewing the operation screen SCop or the remote-control screen SCr. In this aspect, the user can easily determine whether a matter that the icon ICN14 is not displayed or a matter that the icon ICN14 is not selectable occurs due to an error in the web application or occurs due to the web application being executed in the specific period. The second program PG2 may have, for example, a function of notifying that the second function is restricted. In this case, it is also possible to obtain the same effect as the aspect in which the operation screen SCop and the like are displayed on the display unit 380 in different colors between the specific period and the normal period.

As described above, in the embodiment, the first program PG1 has the first function of causing the projector 400 to display the display screen PSC and the second function of presenting the display screen PSC, and the second program PG2 is a web application in which the second function among the functions of the first program PG1 is restricted. Therefore, in the embodiment, it is possible to restrict only the second function for presenting the display screen PSC in the specific period by updating the web application executed in the specific period from the first program PG1 to the second program PG2. Accordingly, in the embodiment, a user can use the projector 400 even in the specific period.

In the embodiment, the second program PG2 may have a function of hiding the icon ICN14 for presenting the display screen PSC among the icons ICN displayed on the terminal device 300 when the first program PG1 is executed. In this case, it is possible to prevent an operation of presenting the display screen PSC from being performed in the specific period.

In the embodiment, the second program PG2 may have a function of displaying, in an unselectable manner, the icon ICN14 for presenting the display screen PSC among the icons ICN displayed on the terminal device 300 when the first program PG1 is executed. In this case, it is also possible to prevent an operation of presenting the display screen PSC from being performed in the specific period.

In the embodiment, the second program PG2 may have a function of replacing, with another icon ICN, the icon ICN14 for presenting the display screen PSC among the icons ICN displayed on the terminal device 300 when the first program PG1 is executed. In this case, it is also possible to prevent an operation of presenting the display screen PSC from being performed in the specific period. When the second program PG2 has a function of replacing the icon ICN14 with the another icon ICN, a space on the display unit 380 of the terminal device 300 in which the icons ICN are displayed can be effectively used.

In the embodiment, the second program PG2 may have a function of displaying an execution result screen in a color different from a color of an execution result screen displayed on the terminal device 300 when the first program PG1 is executed. In this case, a user can easily determine whether the second program PG2 is executed as the web application by viewing the execution result screen. In addition, the user can easily determine whether an error occurs in the web application or a part of functions is restricted by viewing the execution result screen. For example, the user can easily determine whether a matter that the icon ICN14 is not displayed or a matter that the icon ICN14 is not selectable occurs due to an error in the web application or occurs due to the web application being executed in the specific period.

In the embodiment, the second program PG2 may have a function of notifying that a part of functions of the first program PG1 is restricted. Specifically, the second program PG2 may have a function of notifying that the second function is restricted. For example, the second program PG2 may output a message indicating that the second function is restricted by an image or sound. In this case, a user can easily determine whether the second program PG2 is executed as the web application by checking the notification. In addition, the user can easily determine whether an error occurs in the web application or a part of functions is restricted by checking the notification. For example, the user can easily determine whether a matter that the icon ICN14 is not displayed or a matter that the icon ICN14 is not selectable occurs due to an error in the web application or occurs due to the web application being executed in the specific period.

### 3. Third Embodiment

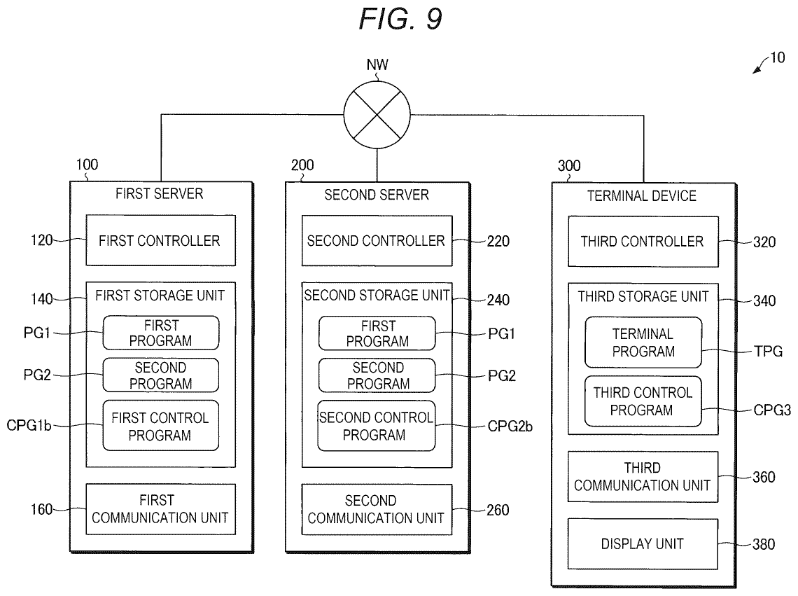

Next, an overview of the information processing system 10 according to a third embodiment will be described with reference to FIG. 9.

FIG. 9 is a diagram showing an example of the information processing system 10 according to the third embodiment. The same elements as the elements described in FIGS. 1 to 8 are denoted by the same reference numerals, and detailed description thereof will be omitted. The information processing system 10 shown in FIG. 9 is similar to the information processing system 10 shown in FIG. 1. For example, similar to the information processing system 10 shown in FIG. 1, the information processing system 10 shown in FIG. 9 includes the first server 100, the second server 200, and the terminal device 300.

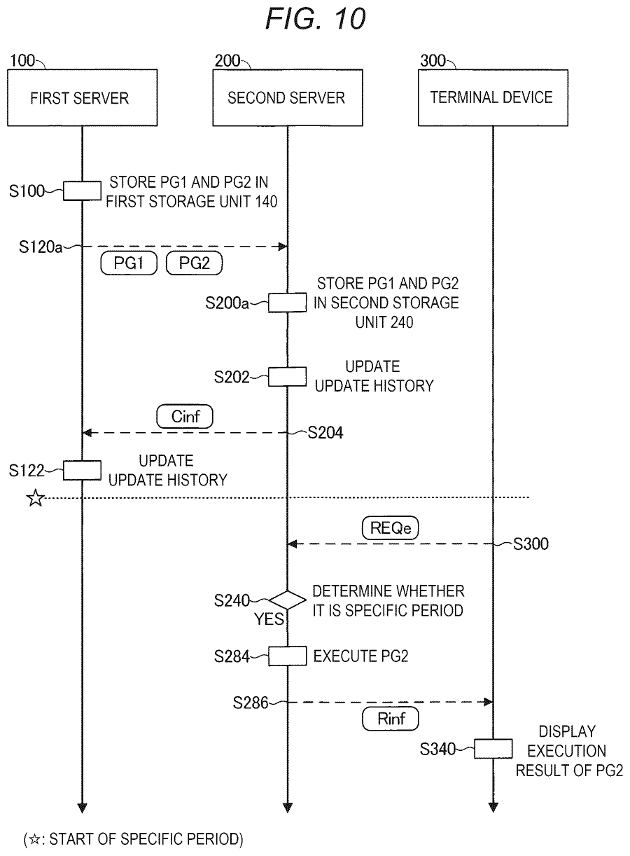

The first server 100 shown in FIG. 9 is similar to the first server 100 shown in FIG. 1. For example, the first server 100 includes the first controller 120, the first storage unit 140, and the first communication unit 160. However, the first server 100 shown in FIG. 9 is different from the first server 100 shown in FIG. 1 in that a first control program CPG1b is stored in the first storage unit 140 instead of the first control program CPG1 and the first controller 120 executes the first control program CPG1b. An operation of the first server 100 when the first controller 120 executes the first control program CPG1b will be described with reference to FIG. 10.

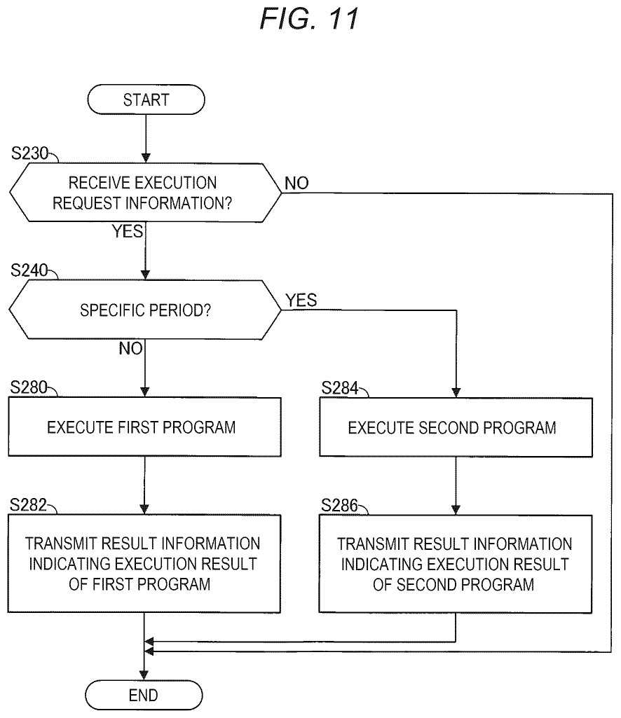

The second server 200 shown in FIG. 9 is similar to the second server 200 shown in FIG. 1. For example, the second server 200 includes the second controller 220, the second storage unit 240, and the second communication unit 260. However, the second server 200 shown in FIG. 9 is different from the second server 200 shown in FIG. 1 in that a second control program CPG2b is stored in the second storage unit 240 instead of the second control program CPG2 and the second controller 220 executes the second control program CPG2b. In the second server 200 shown in FIG. 9, the second storage unit 240 stores both the first program PG1 and the second program PG2. An operation of the second server 200 when the second controller 220 executes the second control program CPG2b will be described with reference to FIGS. 10 and 11.

The terminal device 300 shown in FIG. 9 is similar to the terminal device 300 shown in FIG. 1. For example, the terminal device 300 includes the third controller 320, the third storage unit 340, the third communication unit 360, and the display unit 380.

An example of an operation of the information processing system 10 will be described below with reference to FIG. 10.

FIG. 10 is a diagram showing an example of the operation of the information processing system 10 according to the third embodiment. The same operations as those described in FIG. 2 are denoted by the same reference numerals, and detailed description thereof will be omitted. An asterisk in FIG. 10 is the same as the asterisk in FIG. 2. In FIG. 10, it is assumed that an emergency occurs after processing of step S122 is executed and before processing of step S300 is executed.

First, in step S100, the first controller 120 of the first server 100 stores the first program PG1 and the second program PG2 in the first storage unit 140. Next, in step S120a, the first controller 120 transmits the first program PG1 and the second program PG2 to the second server 200 via the first communication unit 160.

After the processing of step S120a is executed, the second server 200 receives the first program PG1 and the second program PG2. Then, in step S200a, the second controller 220 of the second server 200 stores the first program PG1 and the second program PG2 in the second storage unit 240 as a web application executed in response to a request from the terminal device 300.

Next, in step S202, the second controller 220 updates an update history of the web application. Then, in step S204, the second controller 220 transmits, to the first server 100 via the second communication unit 260, update completion information Cinf indicating that the update of the web application is completed.

After the processing of step S204 is executed, the first server 100 receives the update completion information Cinf. Then, in step S122, the first controller 120 of the first server 100 updates the update history of the web application.

Here, a series of processing in steps S100, S120a, S122, S200a, S202, and S204 corresponds to, for example, initial processing for enabling the web application provided by the first server 100 to be used via the network NW. The initial processing is executed, for example, when the first program PG1 is newly created. The initial processing is also executed, for example, when content of the first program PG1 is changed and when a function restricted by the second program PG2 is changed. After the initial processing is completed, for example, processing of step S300 is executed.

For example, in step S300, the third controller 320 of the terminal device 300 transmits execution request information REQe for requesting execution of the web application to the second server 200 via the third communication unit 360.

After the processing of step S300 is executed, the second server 200 receives the execution request information REQe. Then, in step S240, the second controller 220 of the second server 200 determines whether a current time point is in the specific period. In FIG. 10, since the processing of step S300 is executed after the specific period is started, the second controller 220 determines that the current time point is in the specific period. Therefore, in step S284, between the first program PG1 and the second program PG2 that are stored in the second storage unit 240, the second controller 220 executes the second program PG2 as the web application. Then, in step S286, the second controller 220 transmits, as result information indicating an execution result of the web application, result information Rinf indicating an execution result of the second program PG2 to the terminal device 300 via the second communication unit 260.

After the processing of step S286 is executed, the terminal device 300 receives the result information Rinf. Then, in step S340, the third controller 320 of the terminal device 300 causes the display unit 380 to display the execution result of the second program PG2 as the execution result of the web application based on the result information Rinf.

As described above, in the embodiment, the second program PG2 can be executed as the web application in the specific period without updating the terminal program TPG stored in the third storage unit 340 of the terminal device 300. That is, in the embodiment, when a specific event occurs, a specific function of the first program PG1 can be quickly restricted. In the embodiment, the second server 200 determines whether the current time point is in the specific period in response to the reception of the execution request information REQe. Therefore, in the embodiment, it is possible to prevent the first program PG1 from being executed as the web application in the specific period. That is, in the embodiment, when a specific event occurs, it is possible to prevent a matter that a specific function of the first program PG1 is not restricted.

Although FIG. 10 shows a case where the processing of step S300 is executed in the specific period, when the processing of step S300 is executed in the normal period, the first program PG1 is executed as the web application. In this case, in step S340, the third controller 320 of the terminal device 300 causes the display unit 380 to display an execution result of the first program PG1 as the execution result of the web application based on the result information Rinf.

In the embodiment, the second controller 220 of the second server 200 may determine whether to update the first program PG1 to the second program PG2. When the second controller 220 determines to update the first program PG1 to the second program PG2, the second controller 220 may transmit, to the first server 100 via the second communication unit 260, update request information REQu for requesting to update the first program PG1 to the second program PG2.

Next, an example of an operation of the second server 200 will be described with reference to FIG. 11.

FIG. 11 is a flowchart showing an example of the operation of the second server 200 according to the third embodiment. FIG. 11 shows the operation of the second server 200 after the initial processing described in FIG. 10 is completed. That is, a series of processing of steps S200a, S202, and S204 shown in FIG. 10 is executed before the processing of step S230 is executed. Detailed description of processing similar to the processing described in FIGS. 4 and 10 will be omitted.

First, in step S230, the second controller 220 determines whether the second communication unit 260 receives the execution request information REQe for requesting execution of the web application from the terminal device 300. When the second controller 220 determines that the second communication unit 260 receives the execution request information REQe for requesting the execution of the web application from the terminal device 300, that is, when a determination result in step S230 is positive (step S230/YES), the second controller 220 proceeds the processing to step S240. On the other hand, when the second controller 220 determines that the second communication unit 260 does not receive the execution request information REQe for requesting the execution of the web application from the terminal device 300, that is, when the determination result in step S230 is negative (step S230/NO), the second controller 220 ends the operation shown in FIG. 11.

In step S240, the second controller 220 determines whether a current time point is in the specific period. When it is determined that the current time point is in the specific period, that is, when a determination result in step S240 is positive (step S240/YES), the second controller 220 proceeds the processing to step S284. On the other hand, when the second controller 220 determines that the current time point is not in the specific period, that is, when the determination result in step S240 is negative (step S240/NO), the second controller 220 proceeds the processing to step S280.

In step S280, the second controller 220 executes the first program PG1 as a web application between the first program PG1 and the second program PG2 that are stored in the second storage unit 240.

Then, in step S282, the second controller 220 transmits, as result information indicating an execution result of the web application, result information Rinf indicating an execution result of the first program PG1 to the terminal device 300 via the second communication unit 260. Accordingly, the execution result of the first program PG1 is displayed on the display unit 380 of the terminal device 300 as the execution result of the web application.

As described above, a series of processing of steps S280 and S282 is executed in the normal period. A series of processing of steps S284 and S286 is executed in the specific period.

For example, in step S284, the second controller 220 executes the second program PG2 as the web application between the first program PG1 and the second program PG2 that are stored in the second storage unit 240.

Then, in step S286, the second controller 220 transmits, as result information indicating an execution result of the web application, result information Rinf indicating an execution result of the second program PG2 to the terminal device 300 via the second communication unit 260. Accordingly, the execution result of the second program PG2 is displayed on the display unit 380 of the terminal device 300 as the execution result of the web application.

When the processing of step S282 or S286 ends, the operation shown in FIG. 11 ends.

As described above, in the embodiment, a series of processing from step S240 to step S286 is executed each time the second communication unit 260 receives the execution request information REQe from the terminal device 300 after the initial processing described with reference to FIG. 10 is completed.

As described above, in the embodiment, when the second server 200 receives the execution request information REQe for requesting the execution of the web application from the terminal device 300, the second server 200 determines whether to execute the second program PG2 as the web application, and when the second server 200 determines to execute the second program PG2, the second server 200 executes the second program PG2 and transmits the result information Rinf indicating the execution result of the second program PG2 to the terminal device 300. In the embodiment, the same effects as those of the first embodiment described above can be obtained.

In the embodiment, when the second controller 220 determines to update the first program PG1 to the second program PG2, the second controller 220 may transmit, to the first server 100 via the second communication unit 260, update request information REQu for requesting to update the first program PG1 to the second program PG2. In this aspect, the information processing system 10 includes: the first server 100 including the first communication unit 160, the first storage unit 140 that stores the first program PG1 and the second program PG2 in which a part of functions of the first program PG1 is restricted, and the first controller 120 configured to transmit the first program PG1 and the second program PG2 via the first communication unit 160; the second server 200 including the second communication unit 260, the second storage unit 240 that stores the first program PG1 and the second program PG2 as a web application executed in response to a request from the terminal device 300, and the second controller 220 configured to determine which one of the first program PG1 and the second program PG2 is to be executed as the web application when the second communication unit 260 receives the execution request information REQe for requesting the execution of the web application, configured to execute the second program PG2 when it is determined to execute the second program PG2, and configured to transmit the result information Rinf indicating an execution result of the web application via the second communication unit 260, and when it is determined to update the first program PG1 to the second program PG2, the second controller being configured to transmit, to the first server 100 via the second communication unit 260, the update request information REQu for requesting to update the first program PG1 to the second program PG2; and the terminal device 300 provided with the third communication unit 360, the display unit 380, and the third controller 320 configured to transmit the execution request information REQe to the second server 200 via the third communication unit 360, and configured to cause the display unit 380 to display an execution result of the web application based on the result information Rinf when the third communication unit 360 receives the result information Rinf from the second server 200. In this aspect, the same effects as those of the first embodiment described above can be obtained.

### 4. Fourth Embodiment

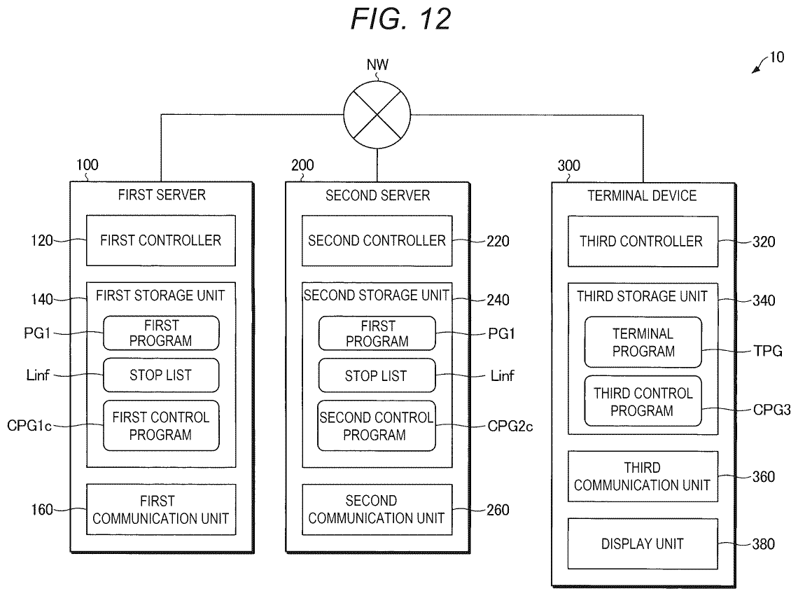

Next, an overview of an information processing system 10 according to a fourth embodiment will be described with reference to FIG. 12.

FIG. 12 is a diagram showing an example of the information processing system 10 according to the fourth embodiment. The same elements as the elements described in FIGS. 1 to 11 are denoted by the same reference numerals, and detailed description thereof will be omitted. The information processing system 10 shown in FIG. 12 is similar to the information processing system 10 shown in FIG. 9. For example, similar to the information processing system 10 shown in FIG. 9, the information processing system 10 shown in FIG. 12 includes the first server 100, the second server 200, and the terminal device 300.

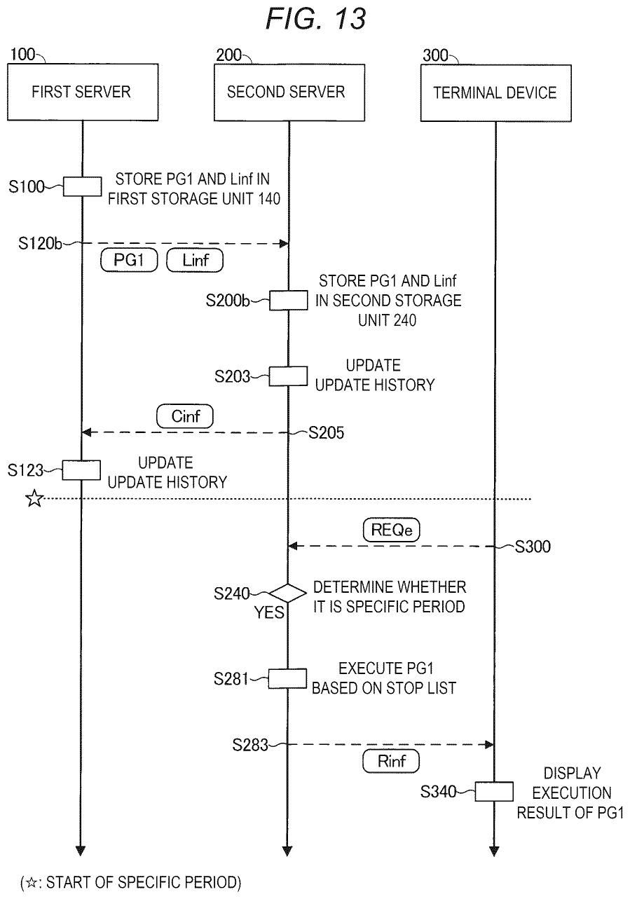

The first server 100 shown in FIG. 12 is similar to the first server 100 shown in FIG. 9. For example, the first server 100 includes the first controller 120, the first storage unit 140, and the first communication unit 160. However, the first server 100 shown in FIG. 12 is different from the first server 100 shown in FIG. 9 in that a first control program CPG1c is stored in the first storage unit 140 instead of the first control program CPG1b and the first controller 120 executes the first control program CPG1c. In the first server 100 shown in FIG. 12, the first storage unit 140 stores a stop list Linf instead of the second program PG2. The stop list Linf indicates a specific function restricted in a specific period among the functions of the first program PG1. That is, in the embodiment, the first program PG1 is a web application that can be executed by switching whether to restrict a specific function. An operation of the first server 100 when the first controller 120 executes the first control program CPG1c will be described with reference to FIG. 13. The stop list Linf is an example of restriction information indicating a function to be restricted among the functions of the first program.

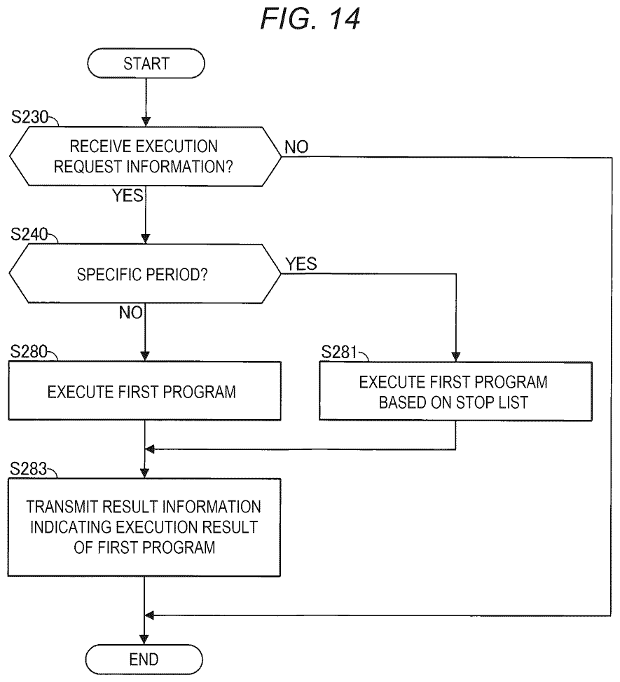

The second server 200 shown in FIG. 12 is similar to the second server 200 shown in FIG. 9. The second server 200 is an example of a server device. For example, the second server 200 includes the second controller 220, the second storage unit 240, and the second communication unit 260. However, the second server 200 shown in FIG. 12 is different from the second server 200 shown in FIG. 9 in that a second control program CPG2c is stored in the second storage unit 240 instead of the second control program CPG2b and the second controller 220 executes the second control program CPG2c. In the second server 200 shown in FIG. 12, the second storage unit 240 stores a stop list Linf instead of the second program PG2. An operation of the second server 200 when the second controller 220 executes the second control program CPG2c will be described with reference to FIGS. 13 and 14.

The terminal device 300 shown in FIG. 12 is similar to the terminal device 300 shown in FIG. 9. For example, the terminal device 300 includes the third controller 320, the third storage unit 340, the third communication unit 360, and the display unit 380.

An example of an operation of the information processing system 10 will be described below with reference to FIG. 13.

FIG. 13 is a diagram showing an example of the operation of the information processing system 10 according to the fourth embodiment. The same operations as those described in FIGS. 2 and 10 are denoted by the same reference numerals, and detailed description thereof will be omitted. An asterisk in FIG. 13 is the same as the asterisk in FIG. 2. In FIG. 13, it is assumed that an emergency occurs after processing of step S123 is executed and before processing of step S300 is executed.

First, in step S100, the first controller 120 of the first server 100 stores the first program PG1 and the stop list Linf in the first storage unit 140. Next, in step S120b, the first controller 120 transmits the first program PG1 and the stop list Linf to the second server 200 via the first communication unit 160.

After the processing of step S120b is executed, the second server 200 receives the first program PG1 and the stop list Linf. Then, in step S200b, the second controller 220 of the second server 200 stores the first program PG1 and the stop list Linf in the second storage unit 240. Accordingly, the first program PG1 is stored in the second storage unit 240 as a web application executed in response to a request from the terminal device 300.

Next, in step S203, the second controller 220 updates an update history of the web application. Then, in step S205, the second controller 220 transmits, to the first server 100 via the second communication unit 260, update completion information Cinf indicating that update of the web application is completed.

After the processing of step S205 is executed, the first server 100 receives the update completion information Cinf. Then, in step S123, the first controller 120 of the first server 100 updates the update history of the web application.

Here, a series of processing in steps S100, S120b, S123, S200b, S203, and S205 corresponds to, for example, initial processing for enabling the web application provided by the first server 100 to be used via the network NW. The initial processing is executed, for example, when the first program PG1 and the stop list Linf are newly created. The initial processing is also executed, for example, when content of the first program PG1 is changed and when content of the stop list Linf is changed. After the initial processing is completed, for example, processing of step S300 is executed.

For example, in step S300, the third controller 320 of the terminal device 300 transmits execution request information REQe for requesting execution of the web application to the second server 200 via the third communication unit 360.

After the processing of step S300 is executed, the second server 200 receives the execution request information REQe. Then, in step S240, the second controller 220 of the second server 200 determines whether a current time point is in the specific period. In FIG. 13, since the processing of step S300 is executed after the specific period is started, the second controller 220 determines that the current time point is in the specific period. Therefore, in step S281, the second controller 220 executes the first program PG1 as the web application based on the stop list Linf. For example, the second controller 220 executes the first program PG1 so that a specific function indicated by the stop list Linf among the functions of the first program PG1 is restricted. That is, the second controller 220 restricts a part of functions of the first program based on the stop list Linf. Then, in step S283, the second controller 220 transmits, as result information indicating an execution result of the web application, result information Rinf indicating an execution result of the first program PG1 to the terminal device 300 via the second communication unit 260. In the example shown in FIG. 13, the result information Rinf indicates an execution result of the first program PG1 in which a specific function is restricted based on the stop list Linf.

After the processing of step S283 is executed, the terminal device 300 receives the result information Rinf. Then, in step S340, the third controller 320 of the terminal device 300 causes the display unit 380 to display an execution result of the first program PG1 based on the result information Rinf as an execution result of the web application.

As described above, in the embodiment, the first program PG1 in which a specific function is restricted can be executed as the web application in the specific period without updating the terminal program TPG stored in the third storage unit 340 of the terminal device 300. That is, in the embodiment, when a specific event occurs, a specific function of the first program PG1 can be quickly restricted. In the embodiment, the second server 200 determines whether the current time point is in the specific period in response to the reception of the execution request information REQe. Therefore, in the embodiment, it is possible to prevent the first program PG1 in which the specific function is not restricted from being executed as the web application in the specific period. That is, in the embodiment, when a specific event occurs, it is possible to prevent a matter that a specific function of the first program PG1 is not restricted.

Although FIG. 13 shows a case where the processing of step S300 is executed in the specific period, when the processing of step S300 is executed in the normal period, the first program PG1 in which the specific function is not restricted is executed as the web application. In this case, in step S340, the third controller 320 of the terminal device 300 causes the display unit 380 to display the execution result of the first program PG1 in which the specific function is not restricted as the execution result of the web application based on the result information Rinf.

Next, an example of an operation of the second server 200 will be described with reference to FIG. 14.

FIG. 14 is a flowchart showing an example of the operation of the second server 200 according to the fourth embodiment. FIG. 14 shows the operation of the second server 200 after the initial processing described in FIG. 13 is completed. That is, a series of processing of steps S200b, S203, and S205 shown in FIG. 13 is executed before processing of step S230 is executed. Detailed description of processing similar to the processing described in FIGS. 11 and 13 will be omitted.

First, in step S230, the second controller 220 determines whether the second communication unit 260 receives the execution request information REQe for requesting execution of the web application from the terminal device 300. When the second controller 220 determines that the second communication unit 260 receives the execution request information REQe for requesting the execution of the web application from the terminal device 300, that is, when a determination result in step S230 is positive (step S230/YES), the second controller 220 proceeds the processing to step S240. On the other hand, when the second controller 220 determines that the second communication unit 260 does not receive the execution request information REQe for requesting the execution of the web application from the terminal device 300, that is, when the determination result in step S230 is negative (step S230/NO), the second controller 220 ends the operation shown in FIG. 14.

In step S240, the second controller 220 determines whether a current time point is in the specific period. When it is determined that the current time point is in the specific period, that is, when a determination result in step S240 is positive (step S240/YES), the second controller 220 proceeds the processing to step S281. On the other hand, when the second controller 220 determines that the current time point is not in the specific period, that is, when the determination result in step S240 is negative (step S240/NO), the second controller 220 proceeds the processing to step S280.

In step S280, the second controller 220 executes the first program PG1 stored in the second storage unit 240 as a web application. For example, the second controller 220 executes the first program PG1 without restricting a specific function indicated by the stop list Linf among the functions of the first program PG1. After executing the processing of step S280, the second controller 220 proceeds the processing to step S283.

As described above, the processing of step S280 is executed in the normal period. The processing of step S281 is executed in the specific period.

For example, in step S281, the second controller 220 executes the first program PG1 stored in the second storage unit 240 as the web application based on the stop list Linf stored in the second storage unit 240. Specifically, for example, the second controller 220 executes the first program PG1 in which the specific function indicated by the stop list Linf among the functions of the first program PG1 is restricted. After executing the processing of step S281, the second controller 220 proceeds the processing to step S283.

In step S283, the second controller 220 transmits, as result information indicating an execution result of the web application, result information Rinf indicating an execution result of the first program PG1 to the terminal device 300 via the second communication unit 260.

For example, in step S283 executed after the processing of step S280 is executed, the second controller 220 transmits the result information Rinf indicating the execution result of the first program PG1 in which the specific function is not restricted to the terminal device 300 via the second communication unit 260. Accordingly, the display unit 380 of the terminal device 300 displays the execution result of the first program PG1 in which the specific function is not restricted as the execution result of the web application.

Further, for example, in step S283 executed after the processing of step S281 is executed, the second controller 220 transmits the result information Rinf indicating the execution result of the first program PG1 in which the specific function is restricted to the terminal device 300 via the second communication unit 260. Accordingly, the display unit 380 of the terminal device 300 displays the execution result of the first program PG1 in which the specific function is restricted as the execution result of the web application.

When the processing of step S283 ends, the operation shown in FIG. 14 ends.

As described above, in the embodiment, a series of processing from step S240 to step S283 is executed each time the second communication unit 260 receives the execution request information REQe from the terminal device 300 after the initial processing described with reference to FIG. 13 is completed.

As described above, in the embodiment, when the second server 200 receives the execution request information REQe for requesting the execution of the web application from the terminal device 300, the second server 200 determines whether to execute, as the web application, the first program PG1 in which the specific function among the functions of the first program PG1 is restricted, and when the second server 200 determines to execute the first program PG1 in which the specific function is restricted, the second server 200 executes the first program PG1 in which the specific function is restricted based on the stop list Linf, and transmits the result information Rinf indicating an execution result of the first program PG1 to the terminal device 300.

In the program update method according to the embodiment, the second server 200 that can communicate with the terminal device 300 stores the first program PG1 executed in response to a request from the terminal device 300 and the stop list Linf indicating a function to be restricted among the functions of the first program PG1, and when it is determined to restrict a part of functions of the first program PG1, the second server 200 restricts a function of the first program PG1 based on the stop list Linf. In the embodiment, the same effects as those of the third embodiment described above can be obtained.

### 5. Fifth Embodiment

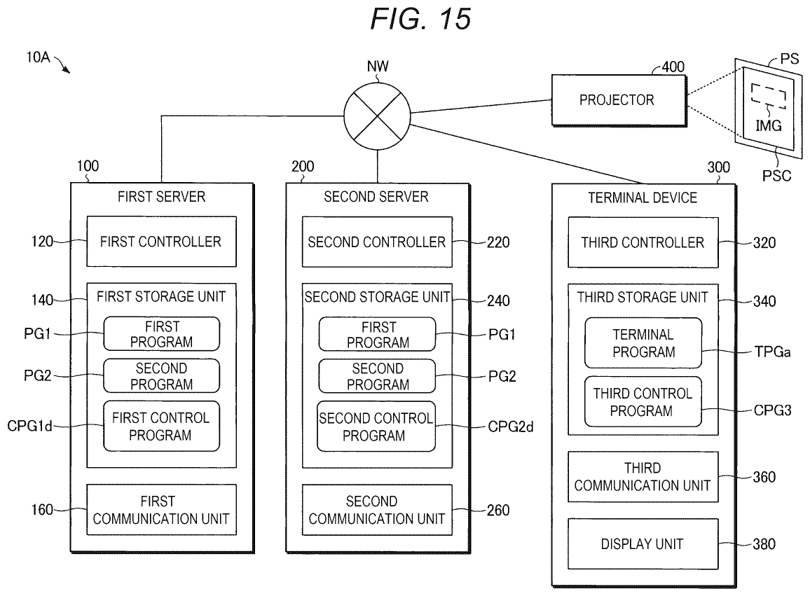

Next, an overview of an information processing system 10A according to a fifth embodiment will be described with reference to FIG. 15.

FIG. 15 is a diagram showing an example of the information processing system 10A according to the fifth embodiment. The same elements as the elements described in FIGS. 1 to 14 are denoted by the same reference numerals, and detailed description thereof will be omitted. The information processing system 10A shown in FIG. 15 is similar to the information processing system 10 shown in FIG. 9 except that the information processing system 10A includes the projector 400.

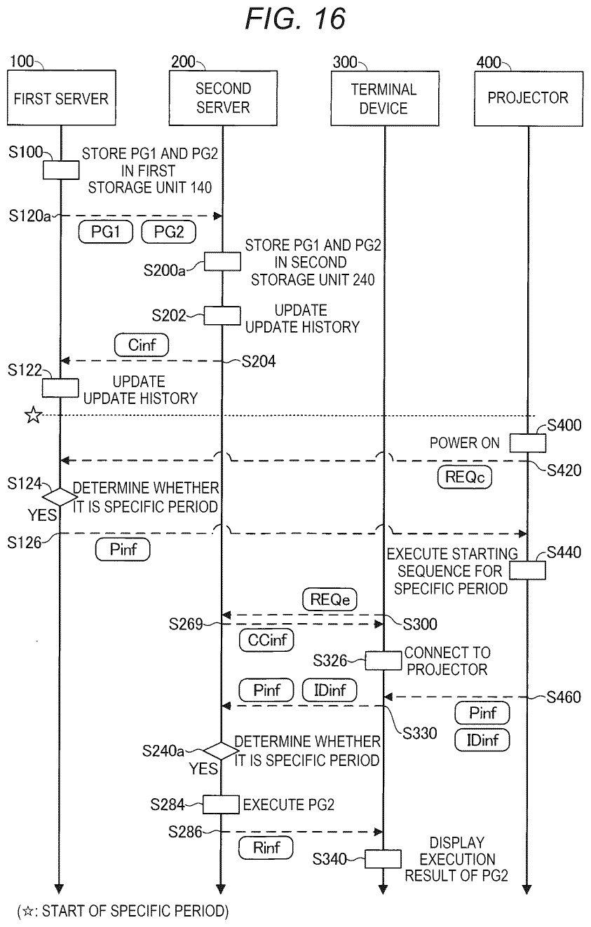

The first server 100 shown in FIG. 15 is similar to the first server 100 shown in FIG. 9. For example, the first server 100 includes the first controller 120, the first storage unit 140, and the first communication unit 160. However, the first server 100 shown in FIG. 15 is different from the first server 100 shown in FIG. 9 in that a first control program CPG1d is stored in the first storage unit 140 instead of the first control program CPG1b and the first controller 120 executes the first control program CPG1d. An operation of the first server 100 when the first controller 120 executes the first control program CPG1d will be described with reference to FIG. 16.

The second server 200 shown in FIG. 15 is similar to the second server 200 shown in FIG. 9. For example, the second server 200 includes the second controller 220, the second storage unit 240, and the second communication unit 260. However, the second server 200 shown in FIG. 15 is different from the second server 200 shown in FIG. 9 in that a second control program CPG2d is stored in the second storage unit 240 instead of the second control program CPG2b and the second controller 220 executes the second control program CPG2d. An operation of the second server 200 when the second controller 220 executes the second control program CPG2d will be described with reference to FIG. 16.

The terminal device 300 shown in FIG. 15 is similar to the terminal device 300 shown in FIG. 9. For example, the terminal device 300 includes the third controller 320, the third storage unit 340, the third communication unit 360, and the display unit 380. However, the terminal device 300 shown in FIG. 15 is different from the terminal device 300 shown in FIG. 9 in that a terminal program TPGa is stored in the third storage unit 340 instead of the terminal program TPG and the third controller 320 executes the terminal program TPGa. That is, an operation of the terminal device 300 shown in FIG. 15 is similar to the operation of the terminal device 300 shown in FIG. 5. For example, the operation of the terminal device 300 shown in FIG. 15 is similar to the operation shown in FIG. 7. In the embodiment, the terminal device 300 functions as an operation device for operating the projector 400 by displaying an execution result of the web application on the display unit 380.

The projector 400 shown in FIG. 15 is similar to the projector 400 shown in FIG. 5.

In the embodiment, it is assumed that the first program PG1 is a web application having a first function of causing the projector 400 to display a display screen PSC and a second function of presenting the display screen PSC, in a similar manner to the second embodiment described above. In the embodiment, it is assumed that the second program is a web application in which the second function among the functions of the first program PG1 is restricted in a similar manner to the second embodiment described above. Therefore, in the embodiment, only the second function of presenting the display screen PSC can be restricted in the specific period, and a user can use the projector 400 even in the specific period, in a similar manner to the second embodiment described above.

An example of an operation of the information processing system 10A will be described below with reference to FIG. 16.

FIG. 16 is a diagram showing an example of the operation of the information processing system 10A according to the fifth embodiment. The same operations as those described in FIGS. 6 and 10 are denoted by the same reference numerals, and detailed description thereof will be omitted. An asterisk in FIG. 16 is the same as the asterisk in FIG. 2. In FIG. 16, it is assumed that an emergency occurs after processing of step S122 is executed and before processing of step S400 is executed.

The operation of the first server 100 shown in FIG. 16 is similar to the operation of the first server 100 shown in FIG. 10 except that a series of processing of steps S124 and S126 is executed. That is, a series of processing of steps S100, S120a, and S122 shown in FIG. 16 is the same as the series of processing of steps S100, S120a, and S122 shown in FIG. 10.

Processing of step S124 is executed, for example, when the first server 100 receives the confirmation request information REQc. For example, after processing of step S420 is executed, the first server 100 receives the confirmation request information REQc. Then, in step S124, the first controller 120 of the first server 100 determines whether a period during which the web application is executed is the specific period. For example, the first controller 120 determines whether the period in which the web application is executed is the specific period by determining whether a current time point is in the specific period by the same processing as the processing of step S240 described in FIG. 2. Then, in step S126, the first controller 120 transmits period information Pinf indicating whether the period in which the web application is executed is the specific period to the projector 400 via the first communication unit 160. In the example shown in FIG. 16, since the specific period is started before the processing of step S124 is executed, the first controller 120 determines that the period during which the web application is executed is the specific period in step S124. Therefore, in step S126, the period information Pinf indicating that the period in which the web application is executed is the specific period is transmitted to the projector 400.

An operation of the projector 400 shown in FIG. 16 is the same as the operation of the projector 400 shown in FIG. 6. That is, a series of processing of steps S400, S420, S440, and S460 shown in FIG. 16 is the same as the series of processing of steps S400, S420, S440, and S460 shown in FIG. 6.

An operation of the terminal device 300 shown in FIG. 16 is the same as the operation of the terminal device 300 shown in FIG. 6. That is, a series of processing of steps S300, S326, S330, and S340 shown in FIG. 16 is the same as the series of processing of steps S300, S326, S330, and S340 shown in FIG. 6.

An operation of the second server 200 shown in FIG. 16 is similar to the operation of the second server 200 shown in FIG. 10 except that processing of step S269 is executed and processing of step S240a is executed instead of the processing of step S240. That is, a series of processing of steps S200a, S202, and S204 shown in FIG. 16 is the same as the series of processing of steps S200a, S202, and S204 shown in FIG. 10. A series of processing of S284 and S286 shown in FIG. 16 is the same as the series of processing of steps S284 and S286 shown in FIG. 10.

The processing of step S269 is executed, for example, when the second server 200 receives the execution request information REQe. For example, after the processing of step S300 is executed, the second server 200 receives the execution request information REQe. Then, in step S269, the second controller 220 of the second server 200 transmits, to the terminal device 300 via the second communication unit 260, connection confirmation information CCinf for confirming whether the terminal device 300 is connected to the projector 400.

The processing of step S240a is executed, for example, when the second server 200 receives the period information Pinf and the identification information IDinf. For example, after the processing of step S330 is executed, the second server 200 receives the period information Pinf and the identification information IDinf of the projector 400. Then, in step S240a, the second controller 220 of the second server 200 determines whether the period during which the web application is executed is the specific period based on the period information Pinf. In the example shown in FIG. 16, the period information Pinf received by the second server 200 from the terminal device 300 indicates that the period during which the web application is executed is the specific period. Therefore, in step S284, between the first program PG1 and the second program PG2 that are stored in the second storage unit 240, the second controller 220 executes the second program PG2 as the web application. Then, in step S286, the second controller 220 transmits, as result information indicating an execution result of the web application, result information Rinf indicating an execution result of the second program PG2 to the terminal device 300 via the second communication unit 260. Accordingly, in step S340, the execution result of the second program PG2 is displayed on the display unit 380 of the terminal device 300 as the execution result of the web application.

As described above, in the embodiment, the second program PG2 can be executed as the web application in the specific period without updating the terminal program TPG stored in the third storage unit 340 of the terminal device 300, in a similar manner to the third embodiment described above. That is, in the embodiment, when a specific event occurs, a specific function of the first program PG1 can be quickly restricted. In the embodiment, it is possible to quickly restrict the specific function of the projector 400 when the projector 400 is powered on in the specific period in which a specific event occurs, in a similar manner to the second embodiment described above.

Similar to FIG. 6, although FIG. 16 shows a case where the processing of step S300 is executed in the specific period, when the processing of step S300 is executed in the normal period, the first program PG1 is executed as the web application. In this case, in step S340, the third controller 320 of the terminal device 300 causes the display unit 380 to display an execution result of the first program PG1 as the execution result of the web application based on the result information Rinf.

An operation of the information processing system 10A is not limited to the example shown in FIG. 16. For example, before the processing of step S126 is executed, the second controller 220 of the second server 200 may determine whether a current time point is in the specific period. In this case, for example, in step S124, the first controller 120 may specify whether the period during which the web application is executed is the specific period. The first server 100 may be implemented by, for example, an information processing device that executes a series of processing from step S100 to step S122 and an information processing device that executes processing for the projector 400 in step S124, step S126, and the like.

As described above, in the embodiment, the same effects as those of the second embodiment and the third embodiment described above can be obtained.

### 6. Modification

The embodiments described above can be modified in various manners. Specific modification aspects will be described below by way of example. Two or more aspects randomly selected from the following examples can be combined as appropriate to an extent that no contradiction occurs. Note that in the modifications described below, elements having equivalent actions and functions to those of the embodiments described above are denoted by the reference numerals referred to in the above description, and detailed description thereof is omitted as appropriate.

### First Modification

In the embodiments described above, when the specific period is started in a period in which the first program PG1 is executed as the web application, the web application may be switched from the first program PG1 to the second program PG2 at a timing exemplified below. For example, the web application may be switched from the first program PG1 to the second program PG2 at a timing when a screen displayed on the display unit 380 of the terminal device 300 is switched. For example, the web application may be switched from the first program PG1 to the second program PG2 at a timing when a screen displayed on the display unit 380 of the terminal device 300 is updated. For example, the web application may be switched from the first program PG1 to the second program PG2 at a timing when processing executed by the web application is separated. For example, the web application may be switched from the first program PG1 to the second program PG2 at a timing when the web application is restarted. When the specific period ends in a period when the second program PG2 is executed as the web application, the web application may be switched from the second program PG2 to the first program PG1 at the above-described timings.

As described above, in the modification, the same effects as those of the embodiments described above can be obtained.

### Second Modification

In the embodiments described above, the specific function of the first program PG1 may be determined, for example, from a plurality of functions of the first program PG1 based on power consumption when each function is executed. In this aspect, for example, when a specific event is power adjustment performed by a power company, it is possible to efficiently restrict a function with large power consumption. The specific function of the first program PG1 may be determined from a plurality of functions of the first program PG1 based on a communication load when each function is executed. In this aspect, for example, when a specific event is a situation in which a communication network such as the network NW is shortage, it is possible to efficiently restrict a function having a large communication load.

### Third Modification

In the fourth embodiment described above, the information processing system may include the projector 400 as in the fifth embodiment described above. As described above, in the modification, the same effects as those of the fourth embodiment and the fifth embodiment described above can be obtained.

### 7. Appendices

From the embodiments described above, for example, the following configurations are known.

A program update method according to an aspect 1 which is a preferred aspect includes: storing, by a second server device configured to communicate with a first server device and a terminal device, a first program as a program to be executed in response to a request from the terminal device; determining, by the second server device, whether to update the first program to a second program in which a part of functions of the first program is restricted; transmitting, by the second server device, update request information for requesting to update the first program to the second program to the first server device when it is determined to update the first program to the second program; transmitting, by the first server device, the second program to the second server device based on the update request information; and updating, by the second server device, the first program to the second program.

According to the aspect 1, it is possible to prevent the update from the first program to the second program from being delayed depending on determination of a user. As a result, in the aspect, when a specific event such as an emergency occurs, a part of functions of the first program can be quickly restricted.

A program execution method according to an aspect 1A which is a preferred aspect is a program execution method in a system including a first server device provided with a first storage unit that stores a first program and a second program in which a part of functions of the first program is restricted, and a second server device provided with a second storage unit that stores the first program and the second program and can communicate with the first server device and a terminal device, in which the second server device determines whether to execute the second program as a program when the second server device receives execution request information for requesting execution of the program from the terminal device, and executes the second program and transmits result information indicating an execution result of the second program to the terminal device when it is determined to execute the second program.

According to the aspect 1A, when a specific event such as an emergency occurs, a part of functions of the first program can be quickly restricted.

A program update method according to an aspect 1B which is a preferred aspect includes: storing, by a server device configured to communicate with a terminal device, a first program executed in response to a request from the terminal device and restriction information indicating a function to be restricted among functions of the first program; and restricting, by the server device, the function of the first program based on the restriction information when it is determined to restrict a part of functions of the first program.

According to the aspect 1B, when a specific event such as an emergency occurs, a specific function of the first program can be quickly restricted.

In a program update method according to an aspect 2 which is a specific example of the aspect 1, or a program update method according to an aspect 2A which is a specific example of the aspect 1A, the first program has a first function of causing a display device to display a first screen and a second function of presenting the first screen, and the second program is a program in which the second function among the functions of the first program is restricted.

In a program update method according to an aspect 2B which is a specific example of the aspect 1B, the first program has a first function of causing a display device to display a first screen and a second function of presenting the first screen, and the specific function includes the second function.

According to the aspects 2, 2A, and 2B, a user can use the display device even when a specific event such as an emergency occurs.

In a program update method according to an aspect 3 which is a specific example of the aspect 2, or a program update method according to an aspect 3A which is a specific example of the aspect 2A, the second program has a function of hiding an operation icon for presenting the first screen among icons displayed on the terminal device when the first program is executed.

In a program update method according to an aspect 3B which is a specific example of the aspect 2B, the specific function includes a function of hiding an operation icon for presenting the first screen among icons displayed on the terminal device when the first program is executed.

According to the aspects 3, 3A, and 3B, it is possible to prevent an operation of presenting the first screen from being performed when a specific event such as an emergency occurs.

In a program update method according to an aspect 4 which is a specific example of the aspect 3, or a program update method according to an aspect 4A which is a specific example of the aspect 3A, the second program has a function of displaying, in an unselectable manner, an operation icon for presenting the first screen among the icons displayed on the terminal device when the first program is executed.

In a program update method according to an aspect 4B which is a specific example of the aspect 3B, the specific function includes a function of displaying, in an unselectable manner, an operation icon for presenting the first screen among the icons displayed on the terminal device when the first program is executed.

According to the aspects 4, 4A, and 4B, it is possible to prevent an operation of presenting the first screen from being performed when a specific event such as an emergency occurs.

In a program update method according to an aspect 5 which is a specific example of the aspect 2 or 3, or a program update method according to an aspect 5A which is a specific example of the aspect 2A or 3A, the second program has a function of replacing, with another icon, an operation icon for presenting the first screen among the icons displayed on the terminal device when the first program is executed.

In a program update method according to an aspect 5B which is a specific example of the aspect 2B or 3B, the specific function includes a function of replacing, with another icon, an operation icon for presenting the first screen among the icons displayed on the terminal device when the first program is executed.

According to the aspects 5, 5A, and 5B, it is possible to prevent an operation of presenting the first screen from being performed when a specific event such as an emergency occurs. Further, according to the aspects 5, 5A, and 5B, a display area of the terminal device on which icons are displayed can be effectively used.

In a program update method according to an aspect 6 which is a specific example of any one of the aspect 1 to the aspect 5, or a program execution method according to an aspect 6A which is a specific example of the aspect 1A to the aspect 5A, the second program has a function of displaying an execution result screen in a color different from an execution result screen displayed on the terminal device when the first program is executed.

In a program update method according to an aspect 6B which is a specific example of the aspect 1B to the aspect 5B, an execution result screen displayed on the terminal device when the first program is executed is displayed in different colors between a case where the first program in which the specific function is not restricted is executed and a case where the first program in which the specific function is restricted is executed.

In the aspects 6 and 6A, a user can easily determine whether an error occurs in the program or a part of functions is restricted by viewing the execution result screen. In the aspect 6B, a user can easily determine whether an error occurs in the program or a specific function is restricted by viewing the execution result screen.

In a program update method according to an aspect 7 which is a specific example of any one of the aspect 1 to the aspect 6, or a program execution method according to an aspect 7A which is a specific example of the aspect 1A to the aspect 6A, the second program has a function of notifying that the part function is restricted.

In a program update method according to an aspect 7B which is a specific example of the aspect 1B to the aspect 6B, the first program has a function of notifying that the part function is restricted.

In the aspects 7 and 7A, a user can easily determine whether an error occurs in the program or whether the part function is restricted by checking the notification. In the aspect 7B, a user can easily determine whether an error occurs in the program or a specific function is restricted by viewing the execution result screen.

An information processing system according to an aspect 8 which is a preferred aspect includes: a first server device including a first controller, a first storage unit, and a first communication unit; a second server device including a second controller, a second storage unit, and a second communication unit; and a terminal device including a third controller, a third communication unit, and a display unit, in which the first storage unit stores a first program and a second program in which a part of functions of the first program is restricted, the second storage unit stores one of the first program and the second program as a program executed in response to a request from the terminal device, when the first communication unit receives update request information for requesting to update the first program to the second program from the second server device, the first controller transmits the second program to the second server device via the first communication unit, when the second communication unit receives execution request information for requesting execution of the program from the terminal device, the second controller executes the program stored in the second storage unit, transmits result information indicating an execution result of the program to the terminal device via the second communication unit, and determines whether to update the first program stored in the second storage unit as the program to the second program, when it is determined to update the first program to the second program, the second controller transmits the update request information to the first server device via the second communication unit, and when the second communication unit receives the second program from the first server device, the second controller updates the first program to the second program transmitted from the first server device, the third controller transmits the execution request information to the second server device via the third communication unit, and when the third communication unit receives the result information from the second server device, the third controller causes the display unit to display an execution result of the program based on the result information.

According to the aspect 8, it is possible to prevent the update from the first program to the second program from being delayed depending on determination of a user. As a result, in the aspect, when a specific event such as an emergency occurs, a part of functions of the first program can be quickly restricted.

An information processing system according to an aspect 8A which is a preferred aspect includes: a first server device including a first controller, a first storage unit, and a first communication unit; a second server device including a second controller, a second storage unit, and a second communication unit; and a terminal device including a third controller, a third communication unit, and a display unit, in which the first storage unit stores a first program and a second program in which a part of functions of the first program is restricted, the second storage unit stores the first program and the second program as a program executed in response to a request from the terminal device, the first controller transmits the first program and the second program to the second server device via the first communication unit, when the second communication unit receives execution request information for requesting execution of the program from the terminal device, the second controller determines whether to execute the second program as the program, when it is determined to execute the second program, the second controller executes the second program and transmits result information indicating an execution result of the second program to the terminal device via the second communication unit, the third controller transmits the execution request information to the second server device via the third communication unit, and when the third communication unit receives the result information from the second server device, the third controller causes the display unit to display the execution result of the program based on the result information.

According to the aspect 8A, when a specific event such as an emergency occurs, a part of functions of the first program can be quickly restricted.

An information processing system according to an aspect 8B which is a preferred aspect includes: a first server device including a first controller, a first storage unit, and a first communication unit; a second server device including a second controller, a second storage unit, and a second communication unit; and a terminal device including a third controller, a third communication unit, and a display unit, in which the first storage unit stores a first program and a stop list indicating a specific function to be restricted among functions of the first program, the second storage unit stores the first program and the stop list, the first control controller transmits the first program and the stop list to the second server device via the first communication unit, when the second communication unit receives execution request information for requesting execution of a program from the terminal device, the second controller determines whether to execute the first program in which the specific function of the functions of the first program is restricted as the program, when it is determined to execute the first program in which the specific function is restricted, the second controller executes the first program in which the specific function is restricted based on the stop list, and transmits result information indicating an execution result of the first program to the terminal device via the second communication unit, the third controller transmits the execution request information to the second server device via the third communication unit, and when the third communication unit receives the result information from the second server device, the third controller causes the display unit to display an execution result of the program based on the result information.

According to the aspect 8B, when a specific event such as an emergency occurs, a part of functions of the first program can be quickly restricted.

An information processing system according to an aspect 8C which is a preferred aspect includes: a first server device including a first communication device, a first storage device configured to store a first program and a second program in which a part of functions of the first program is restricted, and a first control device configured to transmit the first program and the second program via the first communication device; a second server device including a second communication device, a second storage device configured to store the first program and the second program as a program executed in response to a request from a terminal device, and a second control device configured to determine which one of the first program and the second program is to be executed as the program when the second communication device receives execution request information for requesting execution of the program, configured to execute the second program when it is determined to execute the second program, and configured to transmit result information indicating an execution result of the program via the second communication device, and when it is determined to update the first program to the second program, the second control device being configured to transmit, to the first server device via the second communication device, update request information for requesting to update the first program to the second program; and the terminal device including a third communication device, a display device, and a third control device configured to transmit the execution request information to the second server device via the third communication device, and when the third communication device receives the result information from the second server device, the third control device being configured to cause the display device to display an execution result of the program based on the result information.

According to the aspect 8C, when a specific event such as an emergency occurs, a part of functions of the first program can be quickly restricted.

What is claimed is:

1. A program update method comprising:
storing, by a second server device configured to communicate with a first server device and a terminal device, a first program as a program to be executed in response to a request from the terminal device;
determining, by the second server device, whether to update the first program to a second program in which a part of functions of the first program is restricted;
transmitting, by the second server device, update request information for requesting to update the first program to the second program to the first server device when it is determined to update the first program to the second program;
transmitting, by the first server device, the second program to the second server device based on the update request information; and
updating, by the second server device, the first program to the second program.

2. The program update method according to claim 1, wherein
the first program has a first function of causing a display device to display a first screen and a second function of presenting the first screen, and
the second program is a program in which the second function among the functions of the first program is restricted.

3. The program update method according to claim 2, wherein
the second program has a function of hiding an operation icon for presenting the first screen among icons displayed on the terminal device when the first program is executed.

4. The program update method according to claim 2, wherein
the second program has a function of displaying, in an unselectable manner, an operation icon for presenting the first screen among icons displayed on the terminal device when the first program is executed.

5. The program update method according to claim 2, wherein
the second program has a function of replacing, with another icon, an operation icon for presenting the first screen among icons displayed on the terminal device when the first program is executed.

6. The program update method according to claim 1, wherein
the second program has a function of displaying an execution result screen in a color different from a color of an execution result screen displayed on the terminal device when the first program is executed.

7. The program update method according to claim 1, wherein
the second program has a function of notifying that the part of the functions is restricted.

8. A program update method comprising:
storing, by a server device configured to communicate with a terminal device, a first program executed in response to a request from the terminal device, and restriction information indicating a function to be restricted among functions of the first program; and
restricting, by the server device, the function of the first program based on the restriction information when it is determined to restrict a part of functions of the first program.

9. An information processing system comprising:
a first server device including
a first communication device,
a first storage device configured to store a first program and a second program in which a part of functions of the first program is restricted, and
a first control device configured to transmit the first program and the second program via the first communication device;
a second server device including
a second communication device,
a second storage device configured to store the first program and the second program as a program executed in response to a request from a terminal device, and
a second control device
configured to determine which one of the first program and the second program is to be executed as the program when the second communication device receives execution request information for requesting execution of the program,
configured to execute the second program when it is determined to execute the second program, and
configured to transmit result information indicating an execution result of the program via the second communication device, and when it is determined to update the first program to the second program, configured to transmit, to the first server device via the second communication device, update request information for requesting to update the first program to the second program; and
the terminal device including
a third communication device,
a display device, and
a third control device
configured to transmit the execution request information to the second server device via the third communication device, and
configured to cause the display device to display an execution result of the program based on the result information when the third communication device receives the result information from the second server device.
